(19) United States
(12) Patent Application Publication
(10) Pub. No.: US 2007/0140668 A1
(43) Pub. Date: Jun. 21, 2007

(54) STREAM CONTROL DEVICE

(75) Inventors: Tomoki Mizobuchi, Kyoto (JP); Jun Uchida, Osaka (JP); Osamu Goto, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/565,166

(22) Filed: Nov. 30, 2006

(30) Foreign Application Priority Data
Dec. 16, 2005 (JP) 2005-364082

(51) Int. Cl. H04N 5/91

(52) U.S. Cl. 386/131; 719/321

(57) ABSTRACT

The stream control device includes: (a) a series of units from an AV output device to a de-multiplexing unit, which decodes a stream and outputs the decoded data; (b) a parameter list storage unit in which a parameter list is stored, the parameter list including basic list structures connected in series, each of which has parameter information characterizing the respective processing performed by the units from the AV output device to the de-multiplexing unit; (c) a device driver execution unit which executes, based on the parameter list, a device driver which controls the respective processing performed by the units from the AV output device to the de-multiplexing unit; and (d) an application program execution unit which executes an application program which provides the device driver execution unit with a first address of the parameter list as an argument. Thereby, it is possible to reduce processing for designing different software interfaces for the respective device drivers.

### BACKGROUND OF THE INVENTION

(1) Field of the Invention

The present invention relates to a stream control device which is used in various audio-visual apparatuses and the like that record and reproduce stream data in various formats including audio and video data inputted via a camera, a TV tuner, a network, and the like.

(2) Description of the Related Art

Conventionally, in a general stream control device, an application program has generated parameter information for each device driver in an independent format, and provides the parameter information to the device driver. This means that, such a general stream control device has a software interface unique to each device driver, so that when the device driver is changed, it is also necessary to change an application program in order to call the device driver, in addition to the change of the device driver. As a result, diversion of application program is difficult.

For example, in DirectShow™ which Microsoft Corporation™ provides, a software interface of each filter is defined independently, so that a specific filter needs to conform to software interfaces of all filters to which the specific filter is associated.

On the other hand, regarding a series of filters, such as a de-multiplexer and a decoder, which process an audio-visual stream, techniques have been proposed to provide developers with information regarding software interfaces and data structures, which makes it possible to totally control the audio-visual streams, as disclosed in, for example, Japanese Patent Application Laid-Open No. 2005-56364.

However, in the conventional technologies, the software interface is defined for each device driver, such as a de-multiplexer or a decoder, so that an application program needs to be designed in consideration of device synchronization, control sequence, and the like, which are controlled by each driver.

### SUMMARY OF THE INVENTION

An object of the present invention is to provide a stream control device by which processing for designing a software interface for each device driver is reduced.

In order to achieve the above object, the stream control device according to the present invention includes: (a1) a stream processing unit which decodes a stream and outputs the decoded data; (a2) a parameter list storage unit in which a parameter list is stored, the parameter list including, as elements, list structures connected in series, each of which has parameter information characterizing the processing of the stream processing unit; (a3) a device driver execution unit which executes, based on the parameter list, a device driver which controls the processing of the stream processing unit; and (a4) an application program execution unit which executes an application program which provides the device driver execution unit with a first address of the parameter list as an argument.

Thereby, it is possible to define a structure of a device driver, so that information regarding synchronization and control sequence, which the application program execution unit has conventionally been executed for the device driver execution unit, can be added to the interface of the device driver. Then, the application program execution unit calls the device driver concealing a parameter, which is to be passed to the device driver execution unit, in a parameter list, so that it is possible to define a software interface between the device driver and the application program independently without depending on the device driver execution unit, which can realize standardization of the software.

Further, (b) the device driver execution unit may include: (b1) a priority management table holding unit which holds a priority management table in which a priority is registered, the priority being assigned to each element indicated by the parameter information; and (b2) a procedure restructuring unit which restructures the parameter list by sorting the elements included in the parameter list, based on the priority management table.

Thereby, an order of processing the basic list structures in the parameter list is decided based on the priorities, so that the application program execution unit does not need to consider a connecting order of the basic list structures in the parameter list in creation of the parameter list, which enables the application program execution unit to concentrate the processing unique to the application program execution unit.

Furthermore, (c) the device driver execution unit may include (c1) a parameter-processing-type-management-table holding unit which holds a parameter processing type management table in which a processing type is registered, the processing type indicating whether or not synchronization with the processing of the stream processing unit is required, and (c2) the procedure restructuring unit: classifies each of the elements into an element indicating the synchronization with the processing of the stream processing unit or an element not indicating the synchronization with the processing; creates a synchronization parameter list including the element indicating the synchronization, and a non-synchronization parameter list including the element not indicating the synchronization; and restructures the non-synchronization parameter list, by sorting the elements included in the list based on the priority management table.

Thereby, it is possible to perform processing regarding the parameter information, in synchronization with an event generated from the device driver, thereby ensuring starting of the stream processing with a stricter timing.

Still further, (d) the procedure restructuring unit: extracts a bit rate and a transfer size of the stream from the parameter list; calculate a starting cycle of the stream processing unit, according to the bit rate and the transfer size; and decides the priority based on the starting cycle, and update the priority management table using the decided priority.

Thereby, it is possible to dynamically change the priority, according to a bit rate or a transfer size of one transfer, so that it becomes possible to reproduce streams of various bit rates.

Still further, (e) the device driver execution unit may (e1) include a bit rate management unit: extracts a bit rate of the stream and a stream identifier allocated to the stream from the parameter list; and creates and holds a bit rate management table in which the bit rate is associated with the stream identifier, and (e2) the procedure restructuring unit restructures the parameter list by sorting the elements in the list based on the priority management table and the bit rate management table.

Thereby, it is possible to deal with multi-stream processing. It is also possible to define and use priorities for each stream, so that it is no longer necessary for the application program execution unit to consider the processing order for each stream, even when streams of various bit rates are processed.

Still further, (f) wherein the application program execution unit may include: (f1) a parameter information management table holding unit which holds a parameter information management table in which the parameter information is registered; and

(f2) a parameter list creation unit which creates the parameter list based on the parameter information management table.

Still further, (g) wherein the parameter list creation unit may (g1) include a Real-time Data Information (RDI) information extraction unit which extracts a RDI from a stream in a DVD format, and (g2) generates an element in which the RDI is included in the parameter information and add the generated element to the parameter list.

Thereby, even if information included in the audio-visual stream is detected by the stream processing unit and then set, the information is processed based on the priorities, so that it is possible to ensure real-time processing, which provides a user with desirable visual results.

Note that the present invention is realized not only as the stream control device, but also as a method of controlling the stream control device (hereinafter, referred to as a stream control method), a stream control program causing a computer system or the like to execute the stream control method, a recording medium in which the stream control program is recorded, and the like.

Thus, according to the present invention, parameters regarding various kinds of commercial audio-visual apparatuses are concealed in a parameter list, so that it is possible to standardize software interfaces among various software for controlling the various kinds of commercial audio-visual apparatuses, which results in improvement of standardization of software. Furthermore, an order of processing respective parameter information concealed in the parameter list is changed to an appropriate order in the device driver in the processing, so that, even in processing to be executed at real time, an application program can generate the parameter list without considering the order of the processing.

### FURTHER INFORMATION ABOUT TECHNICAL BACKGROUND TO THIS APPLICATION

The disclosure of Japanese Patent Application No. 2005-364082 filed on Dec. 16, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate specific embodiments of the present invention. In the Drawings:

FIG. 1 is a block diagram showing a structure of a stream control device according to the first embodiment of the present invention;

FIG. 2 is a diagram showing a data structure of a basic list structure according to the first embodiment of the present invention;

FIG. 3 is a diagram showing one example of a parameter information management table according to the first embodiment of the present invention;

FIG. 4 is a diagram showing a data structure of a parameter list according to the first embodiment of the present invention;

FIG. 5 is a diagram showing one example of a priority management table according to the first embodiment of the present invention;

FIG. 6 is a diagram showing a data structure of a restructured parameter list according to the first embodiment of the present invention;

FIG. 7 is a diagram showing one example of a stream-control-processing-unit management table according to the first embodiment of the present invention;

FIG. 8 is a diagram showing one example of a cycle management table according to the first embodiment of the present invention;

FIG. 9 is a flowchart of processing performed by an application program execution unit according to the first embodiment of the present invention;

FIG. 10 is a flowchart of processing performed by a device driver execution unit according to the first embodiment of the present invention;

FIG. 11 is a flowchart of procedure restructuring processing according to the first embodiment of the present invention;

FIG. 12 is a block diagram showing a structure of a stream control device according to the second embodiment of the present invention.

FIG. 13 is a diagram showing one example of a parameter processing type management table according to the second embodiment of the present invention;

FIG. 14 is a diagram showing one example of an interrupt event management table according to the second embodiment of the present invention;

FIG. 15 is a flowchart of processing performed by a device driver execution unit according to the second embodiment of the present invention;

FIG. 16 is a flowchart of procedure restructuring processing according to the second embodiment of the present invention;

FIG. 17 is a diagram showing a data structure of a parameter list according to the second embodiment of the present invention;

FIG. 18 is a block diagram showing a structure of a stream control device according to the third embodiment of the present invention;

FIG. 19 is a diagram showing one example of a parameter information management table according to the third embodiment of the present invention;

FIG. 20 is a diagram showing a data structure of RDI according to the third embodiment of the present invention;

FIG. 21 is a flowchart of RDI parameter generation processing according to the third embodiment of the present invention;

FIG. 22 is a diagram showing one example of a cycle management table according to the third embodiment of the present invention;

FIG. 23 is a diagram showing one example of a priority management table according to the third embodiment of the present invention;

FIG. 24 is a diagram showing one example of a stream-control-processing-unit management table according to the third embodiment of the present invention;

FIG. 25 is a block diagram showing a structure of a stream control device according to the fourth embodiment of the present invention;

FIG. 26 is a diagram showing one example of a parameter information management table according to the fourth embodiment of the present invention;

FIG. 27 is a flowchart of processing performed by a device driver execution unit according to the fourth embodiment of the present invention;

FIG. 28 is a flowchart of procedure restructuring processing according to the fourth embodiment of the present invention;

FIG. 29 is a diagram showing one example of a cycle management table according to the fourth embodiment of the present invention;

FIG. 30 is a block diagram showing a structure of a stream control device according to the fifth embodiment of the present invention.

FIG. 31 is a diagram showing a data structure of a basic list structure according to the fifth embodiment of the present invention;

FIG. 32 is a flowchart of processing performed by an application program execution unit according to the fifth embodiment of the present invention;

FIG. 33 is a diagram showing one example of a cycle management table according to the fifth embodiment of the present invention;

FIG. 34 is a diagram showing one example of a priority management table according to the fifth embodiment of the present invention;

FIG. 35 is a flowchart of processing performed by a device driver execution unit according to the fifth embodiment of the present invention;

FIG. 36 is a flowchart of bit rate management processing according to the fifth embodiment of the present invention;

FIG. 37 is a diagram showing one example of a bit rate management table according to the fifth embodiment of the present invention; and

FIG. 38 is a flowchart of priority obtaining processing according to the fifth embodiment of the present invention.

### DESCRIPTION OF THE PREFERRED EMBODIMENT(S)

### First Embodiment

The following describes the first embodiment according to the present invention with reference to the drawings.

The stream control device according to the first embodiment (a) includes: (a1) a stream processing function which decodes a stream and outputs the decoded data; (a2) a parameter list storage function in which a parameter list is stored, the parameter list including, as elements, list structures connected in series, each of which has parameter information characterizing the processing of the stream processing function; (a3) a device driver execution function which executes, ased on the parameter list, a device driver which controls the processing of the stream processing function; and (a4) an application program execution function which executes an application program which provides the device driver execution function with a first address of the parameter list as an argument.

Further, (b) the device driver execution function includes: (b1) a priority management table holding function which holds a priority management table in which a priority is registered, the priority being assigned to each element indicated by the parameter information; and (b2) a procedure restructuring function which restructures the parameter list by sorting the elements included in the parameter list, based on the priority management table.

Furthermore, (c) the application program execution function includes: (c1) a parameter information management table holding function which holds a parameter information management table in which the parameter information is registered; and (c2) a parameter list creation function which creates the parameter list based on the parameter information management table.

Furthermore, (d) the stream processing function includes (d1) a plurality of functions, each of which performs individual processing for the stream, and the device driver execution function includes: (d2) a stream control processing function having a plurality of control functions which controls the functions, respectively; (d3) a stream control processing management table holding function which holds a stream control processing management table in which respective starting addresses for starting the control functions are registered; and (d4) a stream control processing starting function which starts the control functions, respectively, according to the respective elements in the parameter list, based on the stream control processing management table.

Based on the above aspects, a stream control device according to the first embodiment is described below.

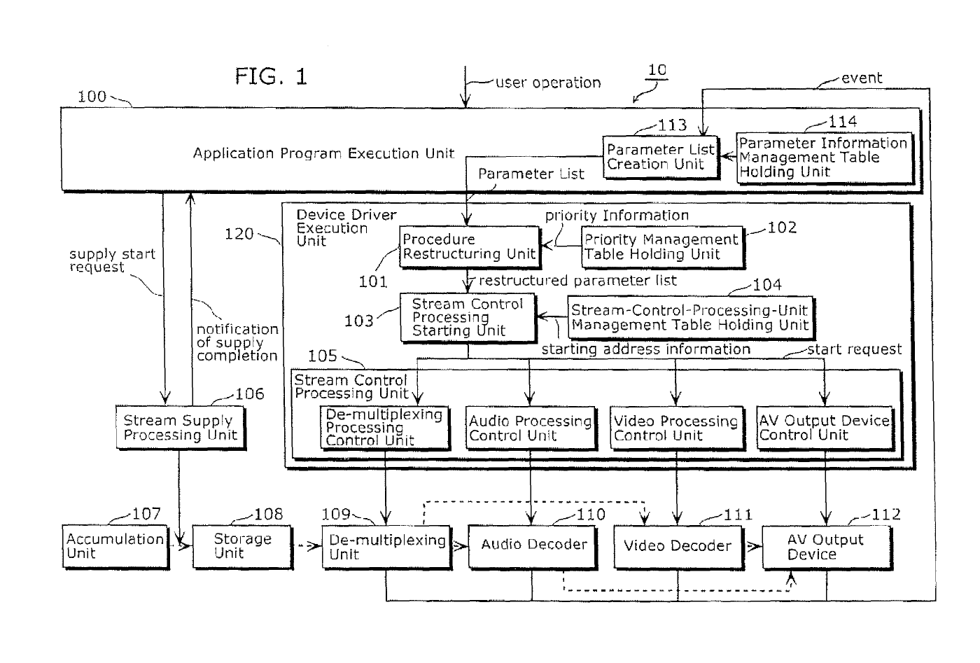

FIG. 1 is a block diagram showing a structure of a stream control device according to the first embodiment. Referring to FIG. 1, a stream control device 10 includes an application program execution unit 100, a device driver execution unit 120, a stream supply processing unit 106, an accumulation unit 107, a storage unit 108, a de-multiplexing unit 109, an audio decoder 110, a video decoder 111, an audio/visual (AV) output device 112, and the like.

Further, the application program execution unit 100 includes a parameter list creation unit 113, a parameter information management table holding unit 114, and the like.

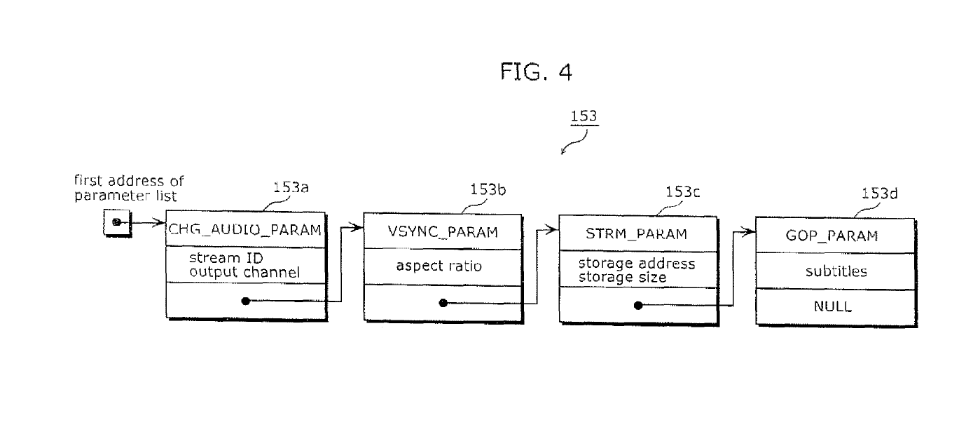

When an event is generated, the parameter list creation unit 113 sets a basic list structure which is to be included in a parameter list, based on a parameter information management table (FIG. 3, for example). The set basic list structure is added next to the last basic list structure in the parameter list (FIG. 4, for example). Furthermore, in synchronization with a Vsync frame whose event generation cycle is the shortest, a first address in a storage area where the first basic list structure of the parameter list is stored is passed to the procedure restructuring unit 101.

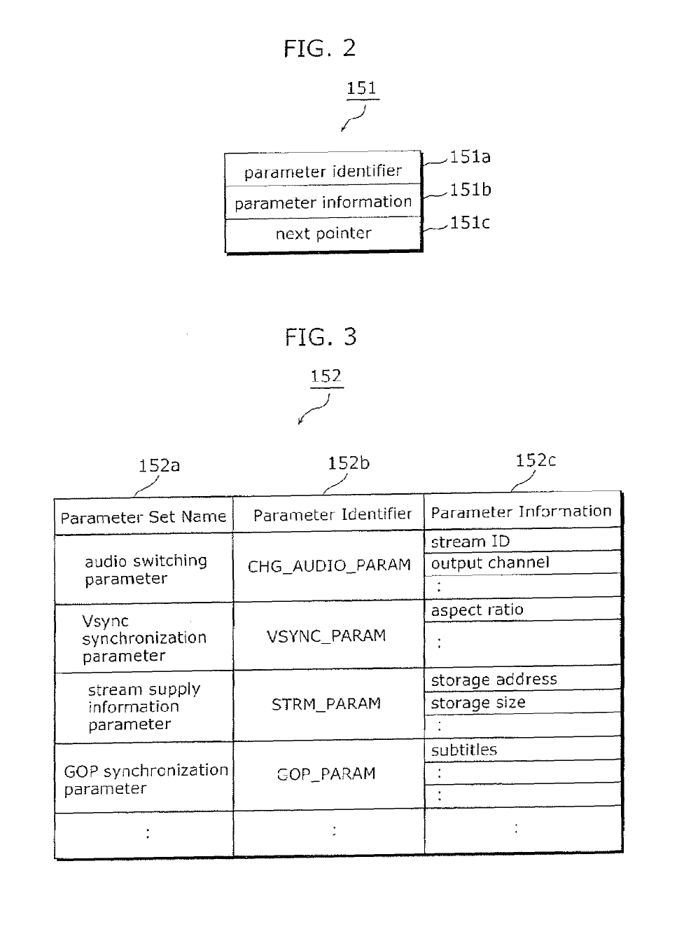

FIG. 2 is a diagram showing a data structure of the basic list structure included in the parameter list according to the first embodiment. Referring to FIG. 2, the basic list structure 151 included in the parameter list has, as members, a parameter identifier (member 151a), parameter information (member 151b), a next pointer (member 151c), and the like. Note that the parameter identifier is an identifier uniquely allocated to each parameter set. The parameter identifier is defined in a parameter information management table. The parameter information is a value of a parameter. The next pointer is an address where a next basic list structure is recorded.

The parameter information management table holding unit 114 holds the parameter information management table (FIG. 3, for example).

FIG. 3 is a diagram showing one example of the parameter information management table according to the first embodiment. Referring to FIG. 3, the parameter information management table 152 includes a record in which a parameter set name (column 152a), a parameter identifier (column 152b), and parameter information (column 152c) are associated with one another. Here, as an example, the parameter information management table 152 includes: a record in which “audio switching parameter”, “CHG_AUDIO_PARAM”, and “stream ID, output channel, . . . ” are associated with one another; a record in which “Vsync synchronization parameter”, “VSYNC_PARAM”, and “aspect ratio, . . . ” are associated with one another; a record in which “stream supply information parameter”, “STRM_PARAM”, and “storage address, storage size, . . . ” are associated with one another; and a record in which “GOP synchronization parameter”, “GOP_PARAM”, and “subtitles, . . . ” are associated with one another.

FIG. 4 is a diagram showing a data structure of the parameter list according to the first embodiment. Here, referring to FIG. 4, as one example, in the parameter list 153, a basic list structure 153a, a basic list structure 153b, a basic list structure 153c, and a basic list structure 153d are connected in series from the first structure.

Regarding the basic list structure 153a, CHG_AUDIO_PARAM is registered as a parameter identifier, stream ID and output channel are registered as parameter information, and the first address of a storage area holding the basic list structure 153b is registered as a next pointer.

Regarding the basic list structure 153b, VSYNC_PARAM is registered as a parameter identifier, an aspect ratio is registered as parameter information, and the first address of a storage area holding the basic list structure 153c is registered as a next pointer.

Regarding the basic list structure 153c, STRM_PARAM is registered as a parameter identifier; a storage address and a storage size are registered as parameter information, and the first address of a storage area holding the basic list structure 153d is registered as a next pointer.

Regarding the basic list structure 153d, GOP_PARAM is registered as a parameter identifier, subtitles are registered as parameter information, and NULL is registered as a next pointer.

Next, referring again to FIG. 1, the device driver execution unit 120 includes a procedure restructuring unit 101, a priority management table holding unit 102, a stream control processing starting unit 103, a stream-control-processing-unit management table holding unit 104, a stream control processing unit 105, and the like.

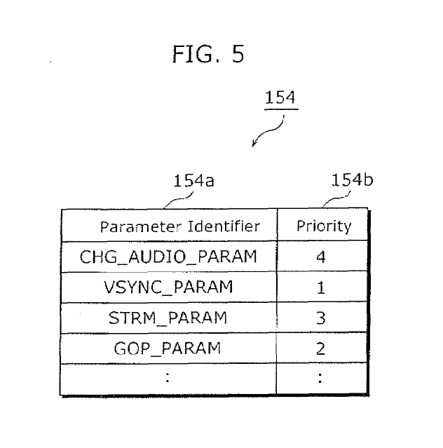

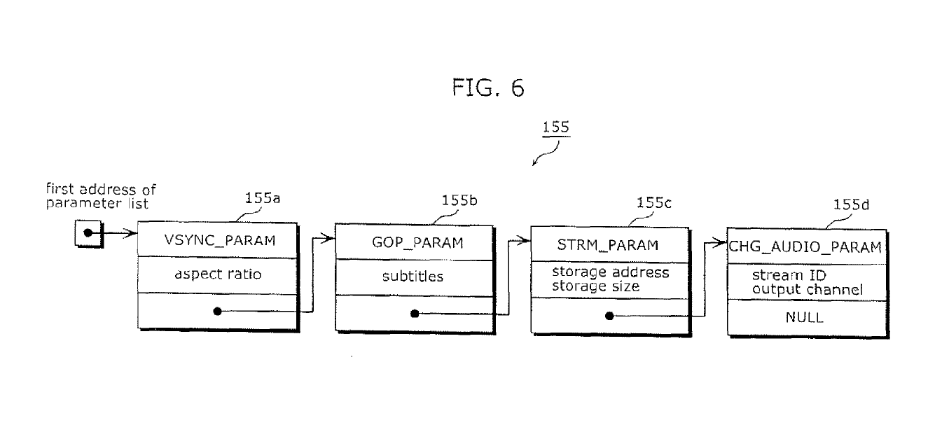

When the first address of the first basics list structure in the parameter list is received from the parameter list creation unit 113, the procedure restructuring unit 101 sequentially scans the basic list structures in the parameter list, based on the received first address. Based on priorities managed in a priority management table (FIG. 5, for example), an order of the basic list structures, which is to be sorted, is examined, then the basic list structures are sorted in the priority order, and the parameter list is restructured. Then, a pointer of the first basic list structure in the restructured parameter list (hereinafter, referred to as a restructured parameter list) is passed to the stream control processing starting unit 103.

The priority management table holding unit 102 holds the priority management table (FIG. 5, for example).

FIG. 5 is a diagram showing one example of the priority management table according to the first embodiment. Referring to FIG. 5, the priority management table 154 includes a record in which a parameter identifier (column 154a) is associated with a priority (column 154b). Here, as an example, the priority management table includes; a record in which “CHG_AUDIO_PARAM” is associated with a priority “4”; a record in which “VSYNC_PARAM” is associated with a priority “1”; a record in which “STRM_PARAM” is associated with a priority “3”; and a record in which “GOP_PARAM” is associated with a priority “2”.

FIG. 6 is a diagram showing a data structure of the restructured parameter list according to the first embodiment. Here, referring to FIG. 6, as one example, in the restructured parameter list 155, a basic list structure 155a, a basic list structure 155b, a basic list structure 155c, and a basic list structure 155d are connected in series from the first structure.

In the basic list structure 155a, instead of the first address of a storage area holding the basic list structure 153c, the first address of a storage area holding the basic list structure 155b is registered as a next pointer.

In the basic list structure 155b, instead of NULL, the first address of a storage area holding the basic list structure 155c is registered as a next pointer.

In the basic list structure 155c, instead of the first address of a storage area holding the basic list structure 153d, the first address of a storage area holding the basic list structure 155d is registered as a next pointer.

In the basic list structure 155d, instead of the first address of a storage area holding the basic list structure 153b, NULL is registered as a next pointer.

Next, referring back to FIG. 1, the stream control processing starting unit 103 extracts the basic list structures from the restructured parameter list sequentially from the first structure. The starting addresses associated with the parameter identifiers of the extracted basic list structures are obtained from a stream-control-processing-unit management table (FIG. 7, for example). A start request and the obtained starting address are passed to the stream control processing unit 105.

The stream-control-processing-unit management table holding unit 104 holds the stream-control-processing-unit management table (FIG. 7, for example).

FIG. 7 is a diagram showing one example of the stream-control-processing-unit management table according to the first embodiment. Referring to FIG. 7, the stream-control-processing-unit management table 156 includes a record in which a parameter identifier (column 156a) is associated with a stream control processing starting address (column 156b). Here, as an example, the stream-control-processing-unit management table 156 includes: a record in which “CHG_AUDIO_PARAM” is associated with “audio processing starting address”; a record in which “VSYNC_PARAM” is associated with “AV output device control starting address”; a record in which “STRM_PARAM” is associated with “de-multiplexing processing starting address”; and a record in which “GOP_PARAM” is associated with “AV output process starting address”.

Next, referring to FIG. 1, the stream control processing unit 105 includes a de-multiplexing processing control unit, an audio processing control unit, a video processing control unit, an AV output device control unit, and the like. Then, when a start request is received from the stream control processing starting unit 103, the stream control processing unit 105 starts a unit corresponding to the starting address received with the start request, among the de-multiplexing processing control unit, the audio processing control unit, the video processing control unit, and the AV output device control unit. Here, when the starting address is an audio processing starting address, the audio processing control unit is started. When the starting address is an AV-output-device-control-unit starting address, the AV output device control unit is started. When the starting address is a de-multiplexing processing starting address, the de-multiplexing processing control unit is started. When the starting address is an AV output process starting address, the AV output device control unit is started.

Further, the application program execution unit 100 provides a supply start request and a stream identifier allocated to a stream to be reproduced, to the stream supply processing unit 106.

When the supply start request is received from the application program execution unit 100, the stream supply processing unit 106 reads out the stream identified by the stream identifier received together with the supply start request, from the accumulation unit 107. The read-out stream is developed in the storage unit 108. When the development is completed, a supply completion notification is given to the application program execution unit 100.

The accumulation unit 107 accumulates streams. The storage unit 108 stores the streams.

When the supply completion notification is provided from the application program execution unit 100 via the device driver execution unit 120, the de-multiplexing unit 109 separates the multiplexed stream into an audio stream and a video stream, and provides the audio stream to the audio decoder 110 and the video stream to the video decoder 111.

The audio decoder 110 decades the audio stream provided from the de-multiplexing unit 109. The result of the decoding is outputted to the AV output device 112. The video decoder 111 decodes the video stream provided from the de-multiplexing unit 109. The result of the decoding is outputted to the AV output device 112. Moreover, when decoding of one frame completes, the audio decoder 110 and the video decoder 111 notifies the parameter list creation unit 113 of decoding information, such as information regarding monaural/stereo and an aspect ratio. Further, at timings of Vsync or state transition, the audio decoder 110 and the video decoder 111 notifies the parameter list creation unit 113 of event information regarding the Vsync or the state transition.

Then, the parameter list creation unit 113 sets basic list structures in a parameter list of each frame, in the AV output device 112, based on the decoding information and the event information notified from the audio decoder 110 and the video decoder 111. Further, even when reproduction is requested to be stopped by user's operation or the like, the parameter list creation unit 113 performs decoding stop processing for the audio decoder 110 and the video decoder 111 via the device driver execution unit 120.

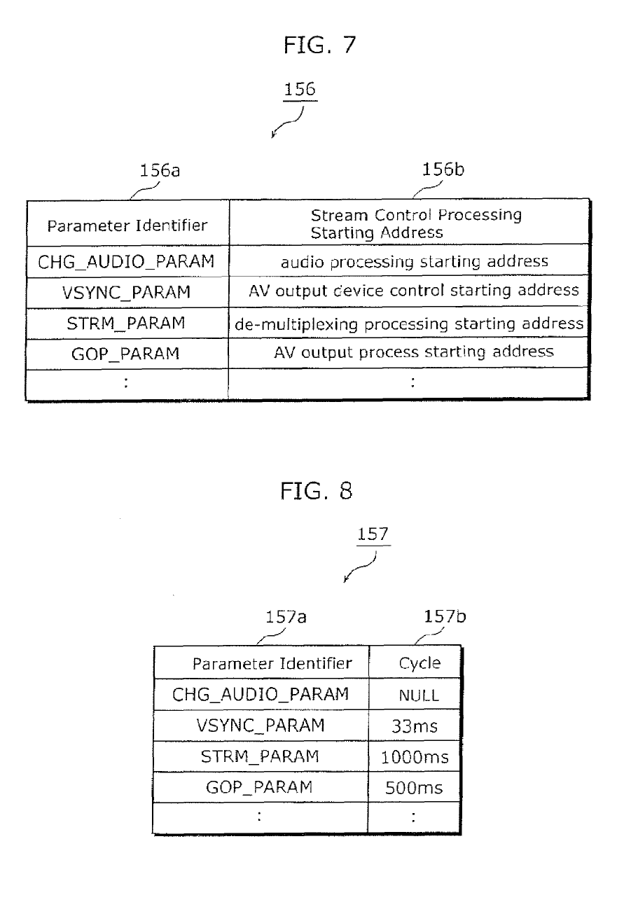

Note that a higher priority is assigned to a parameter identifier whose cycle is shorter, based on a cycle management table (FIG. 8, for example). Here, a smaller value is set to a higher priority. More specifically, a priority “1” is assigned to a parameter identifier whose cycle is the shortest. Other priorities are sequentially assigned to parameter identifiers in this manner, and the lowest priority is finally assigned to a parameter identifier of a noncycling event, such as a user's operation.

FIG. 8 is a diagram showing an example of a cycle management table according to the first embodiment. Referring to FIG. 8, the cycle management table 157 includes: a record in which a parameter identifier (column 157a) is associated with a cycle (column 157b). Here, as an example, the cycle management table 157 includes: a record in which “CHG_AUDIO_PARAM” is associated with “NULL”; a record in which “VSYNC_PARAM” is associated with “33 ms”; a record in which “STRM_PARAM” is associated with “1000 ms”; a record in which “GOP_PARAM” is associated with “50 ms”.

Here, a cycle of STRM_PARAM is calculated, assuming that a transfer size of one transfer is 9 Mbit and a bit rate is 9 Mbps.

Note that the stream control device 10 further has a parameter list storing function, which is not shown in the figure, for storing the parameter list created by the parameter list creation unit 113. The stream control device 10 also has a cycle management table holding function for holding the cycle management table.

Next, processing performed by the stream control device 10 having the above-described structure is described.

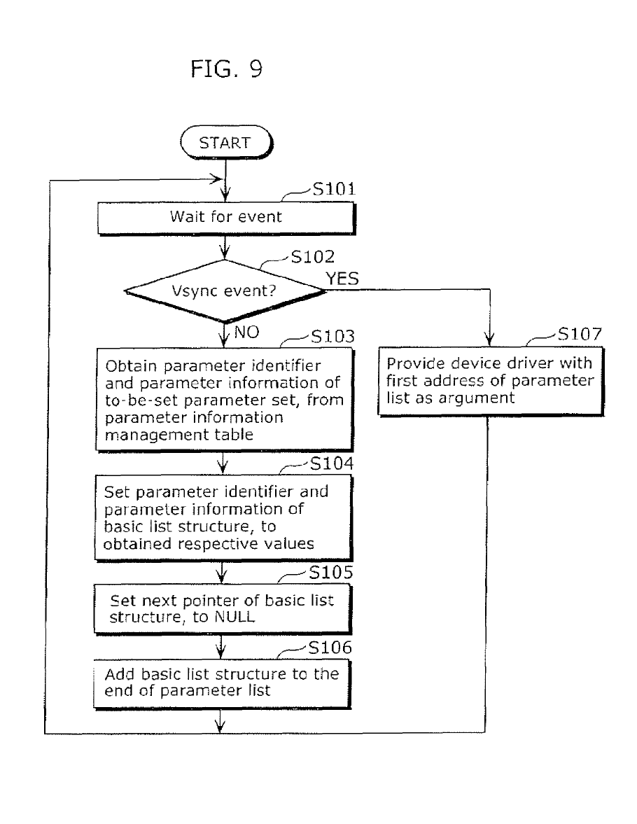

FIG. 9 is a flowchart of processing performed by the application program execution unit 100 according to the first embodiment. Referring to FIG. 9, when a supply completion notification, a notification of decoding information, or an event of user's operation occurs (S101), the application program execution unit 100 has the parameter list creation unit 113 creates a parameter (basic list structure) at timing of the above occurrence.

Here, based on a parameter information management table 152 (FIG. 3, for example) (S103), the parameter list creation unit 113 sets a parameter identifier and parameter information for the created parameter (basic list structure) (S104). A next pointer is set to NULL (S105) in the parameter (basic list structure), and the parameter (basic list structure) is added next to the last basic list structure in the parameter list.

In this way, in synchronization with a Vsync frame whose event occurrence cycle is the shortest (S102), the application program execution unit 100 provides the first address of the first basic list structure in the parameter list created at each event occurrence, to the procedure restructuring unit 101 in the device driver execution unit 120 (S107). When the addition to the parameter list, or processing of the device driver execution unit 120 is completed, the processing of the application program execution unit 100 is returned to the waiting for events, and repeats the above-described steps.

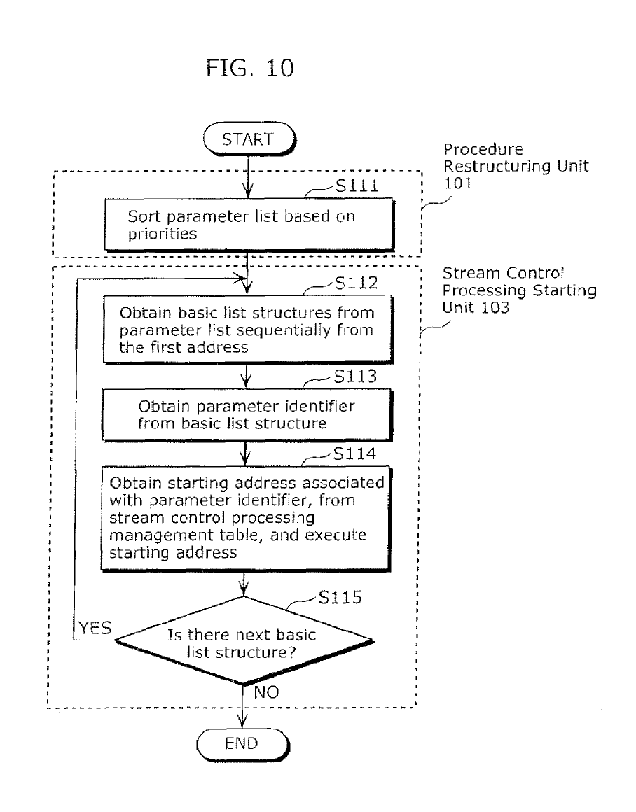

FIG. 10 is a flowchart of processing performed by the device driver execution unit 120 according to the first embodiment. Referring to FIG. 10, the procedure restructuring unit 101 scans basic list structures in a parameter list 153 (FIG. 4, for example) sequentially from the first structure, then sorts the basic list structures by changing the connecting order based on priorities registered in a priority management table 154 (FIG. 5, for example), and thereby creates a restructured parameter list 155 (FIG. 6, for example) (S111). An address of the first basic list structure 155a in the restructured parameter list 155 is notified to the stream control processing starting unit 103.

The stream control processing starting unit 103 obtains the basic list structures from the restructured parameter list 155 sequentially from the first structure (S112). In the first basic list structure 155a, VSYNC_PARAM indicating a Vsync synchronization parameter is registered as a parameter identifier (S113). The stream control processing starting unit 103 obtains a starting address of the stream control processing unit 105 which processes a parameter indicated by VSYNC_PARAM, from a stream-control-processing-unit management table 156 (FIG. 7, for example), and passes the obtained starting address and a start request to the stream control processing unit 105, so that the stream control processing unit 105 starts the AV output process control unit 112 (S114). When the starting of the AV output process control unit 112, which is stream control processing for VSYNC_PARAM, is complete, referring to a next pointer in the basic list structure, the second basic list structure 155b is obtained, and the stream control processing unit 105 corresponding to the parameter identifier of the second basic list structure 155b is started in the same manner as described for the first basic list structure 155a. Subsequently, the above-described steps are repeated up to the last basic list structure 155d (S115).

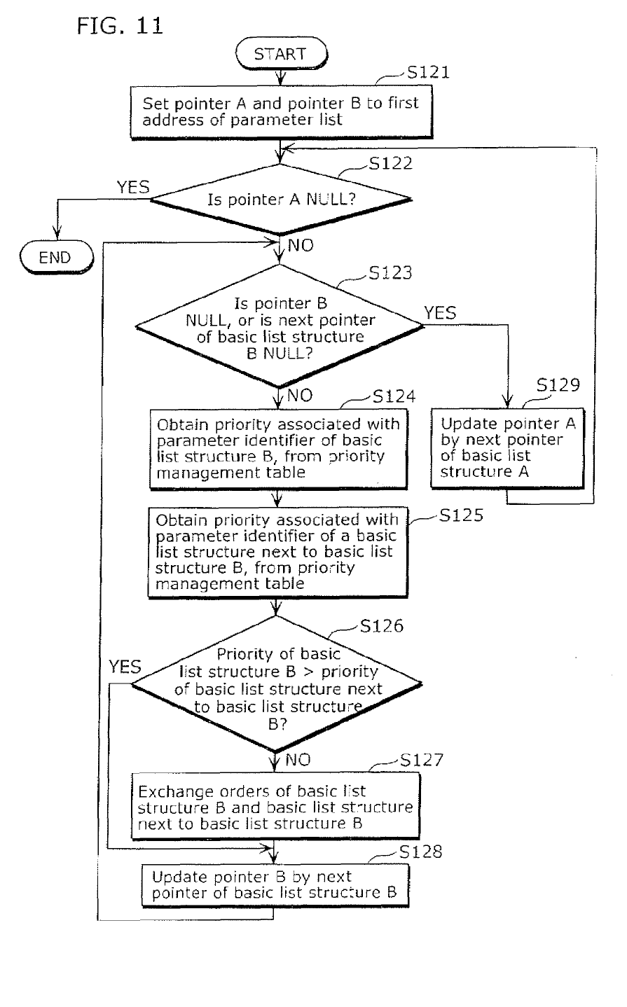

Note that, as shown in FIG. 11, the procedure restructuring unit 101 realizes the sorting based on priorities (S126 and S127), by examining the order of the basic list structures to be sorted, using the priorities (S121 to S125).

Thus, in the stream control device 10 according to the first embodiment, the application program execution unit 100 calls the device driver, concealing a parameter, which is to be passed to the device driver execution unit 120, so that it is possible to define a software interface between the device driver and the application program independently without depending on the device driver execution unit 120, which can realize standardization of software. Furthermore, an order of processing the basic list structures in the parameter list is decided based on the priorities, so that the application program execution unit 100 does not need to consider a connecting order of the basic list structures in the parameter list in creation of the parameter list, which enables the application program execution unit 100 to concentrate the processing unique to the application program execution unit 100.

### Second Embodiment

Next, the second embodiment according to the present invention is described with reference to the drawings.

In the stream control device according to the second embodiment, (e) (e1) the device driver execution function includes a parameter-processing-type-management-table holding function which holds a parameter processing type management table in which a processing type is registered, the processing type indicating whether or not synchronization with the processing of the stream processing function is required, and (e2) the procedure restructuring function: classifies each of the elements into an element indicating the synchronization with the processing of the stream processing function or an element not indicating the synchronization with the processing; creates a synchronization parameter list including the element indicating the synchronization, and a non-synchronization parameter list including the element not indicating the synchronization; and restructures the non-synchronization parameter list, by sorting the elements included in the list based on the priority management table.

Based on the above aspect, the stream control device according to the second embodiment is described below. Note that the same components are designated by the same reference numerals in the first embodiment, and their structures and functions are the same as described above.

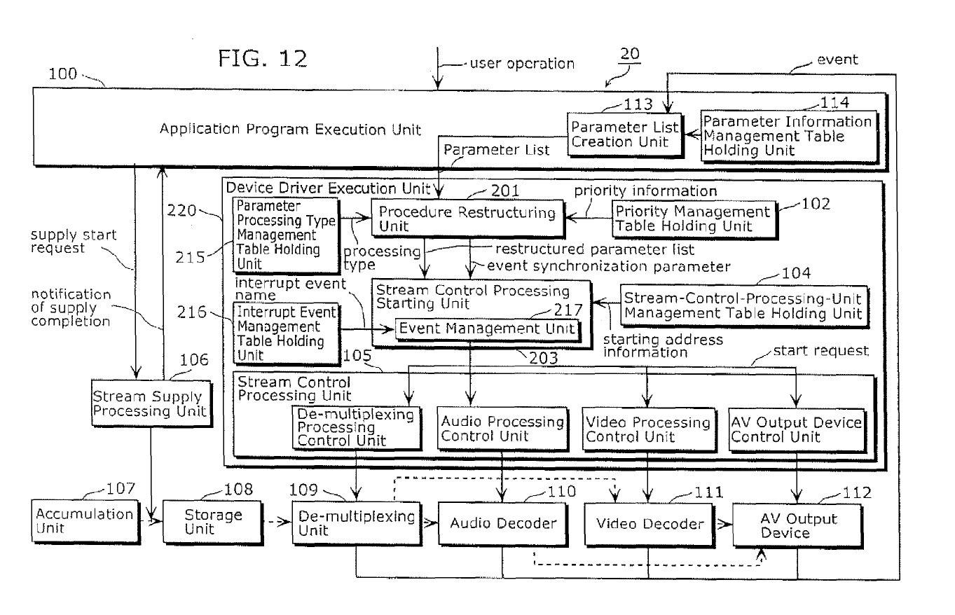

FIG. 12 is a block diagram showing a structure of the stream control device according to the second embodiment. Referring to FIG. 12, the stream control device 20 of the second embodiment differs from the stream control device 10 of the first embodiment in that the device driver execution unit 120 is replaced to a device driver execution unit 220.

The device driver execution unit 220 includes a procedure restructuring unit 201 and a stream control processing starting unit 203, instead of the procedure restructuring unit 101 and the stream control processing starting unit 103. Moreover, the device driver execution unit 220 further includes a parameter-processing-type-management-table holding unit 215 and an interrupt event management table holding unit 216.

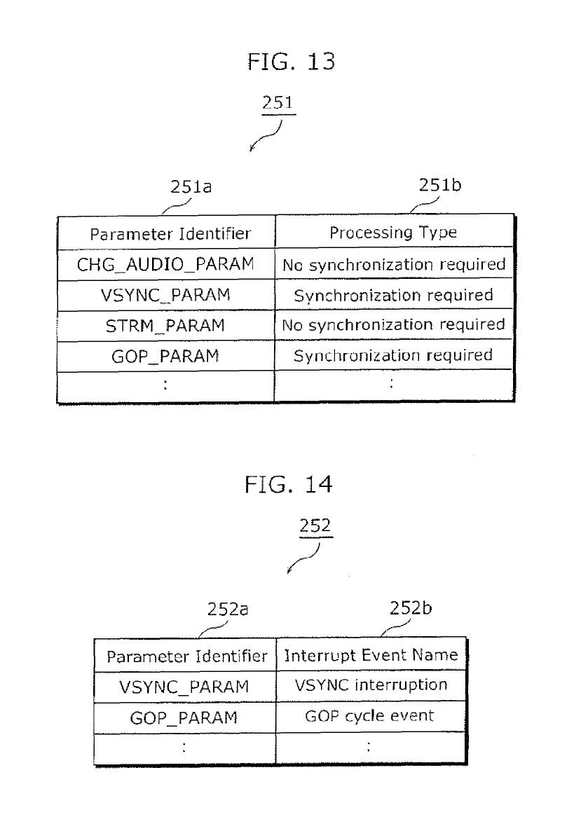

The procedure restructuring unit 201 obtains a processing type of each structure in the parameter list, from a parameter processing type management table (FIG. 13, for example). Then, based on the obtained processing type, the basic list structure is classified into a parameter list or an event synchronization parameter. The obtained priority and event synchronization parameter including the processing type are provided to the stream control processing starting unit 203.

The parameter-processing-type-management-table holding unit 215 holds a parameter processing type management table (FIG. 13, for example).

FIG. 13 is a diagram showing one example of the parameter processing type management table according to the second embodiment. Referring to FIG. 13, the parameter processing type management table 251 includes a record in which a parameter identifier (column 251a) is associated with a processing type (column 251b). Here, as an example, the parameter processing type management table 251 includes: a record in which “CHG_AUDIO_PARAM” is associated with “no synchronization required”; a record in which “VSYNC_PARAM” is associated with “synchronization required”; a record in which “STRM_PARAM” is associated with “no synchronization required”; a record in which “GOP_PARAM” is associated with “synchronization required”.

Next, as shown in FIG. 12, the stream control processing starting unit 203 receives the event synchronization parameter provided from the procedure restructuring unit 201. Based on the received event synchronization parameter, a judgment is made as to whether or not a processing type of the parameter is synchronization with an event, in other words, whether or not synchronization with an event is required. As a result of the judgment, if the processing type is “no synchronization required”, in other words, if the synchronization with an event is not required, then the basic list structures in the parameter list are sorted by changing the connecting order based on priorities. On the other hand, if the processing type is “synchronization required”, in other words, if the synchronization with an event is required, then an interrupt event name associated with the parameter identifier is obtained from an interrupt event management table (FIG. 14, for example). Further, a stream control processing starting address associated with the parameter identifier is obtained from a stream-control-processing-unit management table (FIG. 7, for example). The obtained stream control processing starting address is registered in association with the obtained interrupt 30 event name, as an interrupt handler, into the event processing unit 217 based on the notified priorities.

The interrupt event management table holding unit 216 holds a interrupt event management table (FIG. 14, for example).

FIG. 14 is a diagram showing one example of the interrupt event management table according to the second embodiment. Referring to FIG. 14, the interrupt event management table 252 includes a record in which a parameter identifier (column 252a) is associated with an interrupt event name (column 252b). Here, as an example, the interrupt event management table 252 includes: a record in which “VSYNC_PARAM” is associated with “VSYNC interruption”; and a record in which “GOP_PARAM” is associated with “GOP cycle event”.

When an interrupt event is received, the event processing unit 217 starts an interrupt handler registered for the interruption. In the case where multiple interruption events are received, a high-priority interrupt handler is started. Note that the event processing unit 217 may be realized using an interruption processing function implemented by a general-purpose operating system (OS).

Next, processing performed by the stream control device 20 having the above-described structure is described. Note that the same steps are designated by the same reference numerals in the first embodiment, and their operations are the same as described above.

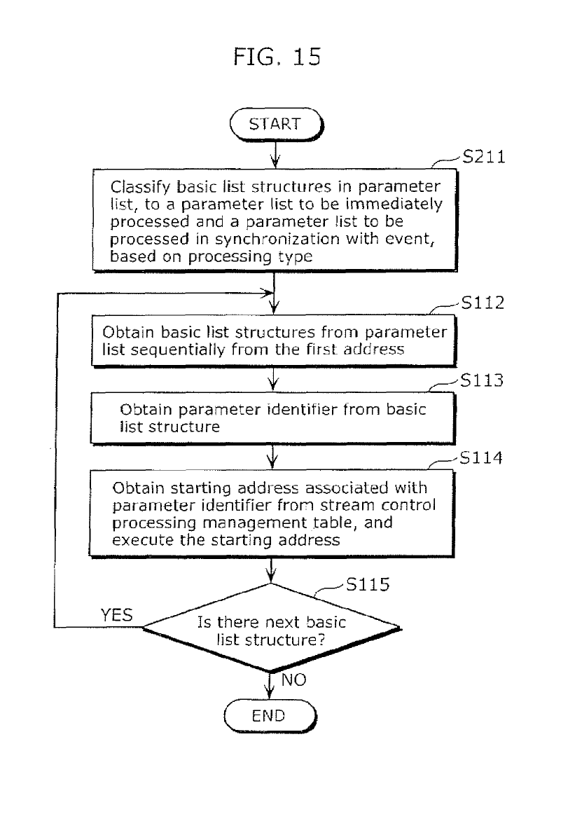

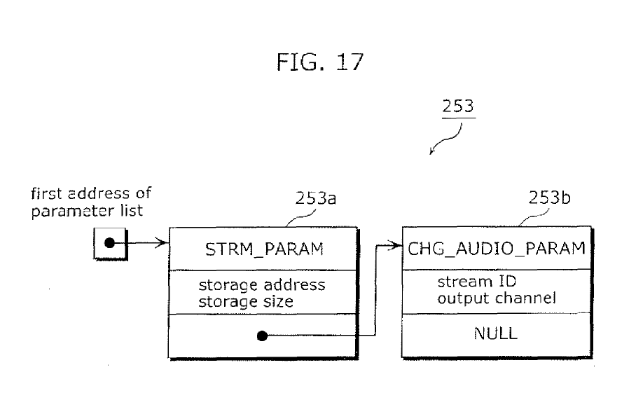

FIG. 15 is a flowchart of processing performed by the device driver execution unit 220 according to the second embodiment. Referring to FIG. 15, the procedure restructuring unit 201 scans basic list structures in a parameter list 153 (FIG. 4, for example) sequentially from the first structure. Then, each structure is classified into a basic list structure to be immediately processed or a basic list structure to be processed in synchronization with an event, based on the processing type registered in the parameter processing type management table 251 (FIG. 13, for example) and the priorities registered in the priority management table 154 (FIG. 5, for example). Thereby, the basic list structures are sorted by changing the connecting order, in order to create a restructured parameter list 253 (FIG. 17, for example) (S211).

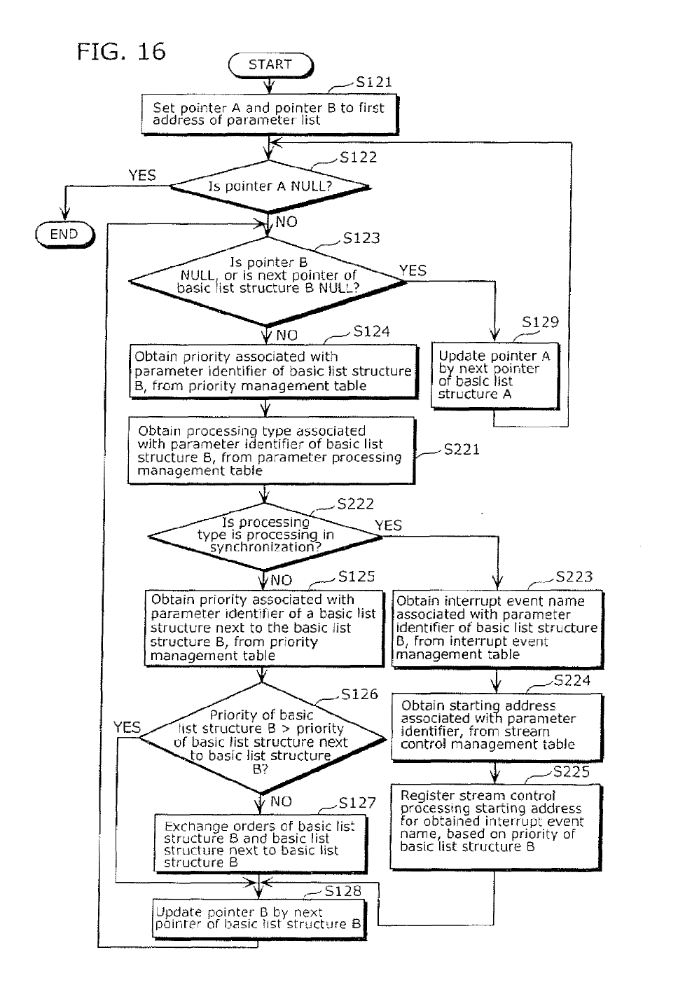

Here, as shown in FIG. 16, when the parameter list provided from the application program execution unit 100 is sorted in a priority order, the procedure restructuring unit 201 obtains, for each basic list structure, information indicating whether or not the synchronization with an event is required, from the parameter processing type management table 251 (FIG. 13, for example). If the synchronization with an event is not required (NO at S222), then the basic list structures are sorted by changing the connecting order based on priorities, in the same manner as described in the first embodiment (S125 to S127). On the other hand, if the synchronization with an event is required (YES at S222), then the stream control processing starting unit 203 obtains an interrupt event name associated with the parameter identifier from the interrupt event management table 252 (FIG. 14, for example) (S223), also obtains a stream processing starting address from the stream-control-processing-unit management table 156 (FIG. 7, for example) (S224), and registers, as an interrupt handler, the obtained stream processing starting address for the obtained interrupt event name, into the event processing unit 217 based on the notified priorities (S225).

FIG. 17 is a diagram showing a data structure of the restructured parameter list according to the second embodiment. Here, referring to FIG. 17, as an example, in the restructured parameter list 253, a basic list structure 253a and a basic list structure 253b are connected in series from the first structure.

In the basic list structure 253a, STRM_PARAM is registered as a parameter identifier, a storage address and a storage size are registered as parameter information, and an address of the basic list structure 253b is registered as a next pointer.

In the basic list structure 253b, CHG_AUDIO_PARAM is registered in a parameter identifier, a stream ID and an output channel are registered as parameter information, and NULL is registered as a next pointer.

For example, the stream control processing starting unit 203 obtains “VSYNC interruption” associated with “VSYNC_PARAM”, from the interrupt event management table 252 (FIG. 14, for example). “AV-output-device-control-unit starting address” associated with “VSYNC_PARAM is obtained from the stream-control-processing-unit management table 156 (FIG. 7, for example). “AV-output-device-control-unit starting address” for “VSYNC interrupt event” is assigned with a priority “1” and registered in the event processing unit 217 as an interrupt handler.

Likewise, “GOP cycle event” associated with “GOP_PARAM” is obtained from the interrupt event management table 252 (FIG. 14, for example). “AV output processing starting address” associated with “GOP_PARAM” is obtained from the stream-control-processing-unit management table 156 (FIG. 7, for example). “AV output processing starting address” for “GOP cycle event” is assigned with a priority “2” and registered into the event processing unit 217 as an interrupt handler.

Therefore, when a “GOP cycle event” occurs, the AV output device control unit is started to process a parameter GOP_PARAM. However, if VSYNC interruption occurs during the GOP_PARAM processing, the AV output device control unit is started by another context to process a parameter VSYNC_PARAM as a priority.

As described above, in the stream control device 20 according to the second embodiment, it is possible to perform processing for a parameter in synchronization with an event generated from the driver device, thereby ensuring starting of the stream processing with a stricter timing.

This means that, in the stream control device 10 according to the first embodiment, a parameter list created in the application program execution unit 100 is processed immediately in a priority order of parameters. Therefore, if a timing of a parameter is to be set in synchronization with a device, the timing needs to be managed by the application software.

However, in the stream control device 20 according to the second embodiment, by changing the processing performed by the procedure restructuring unit 201 and the stream control processing starting unit 203 based on the parameter processing type management table 251 (FIG. 13, for example) and the interrupt event management table 252 (FIG. 14, for example), it is possible to set the timing of the parameter processing timing in synchronization with an event.

### Third Embodiment

Next, the third embodiment according to the present invention is described with reference to the drawings.

In the stream control device according to the third embodiment, (f) the parameter list creation function (f1) includes a Real-time Data Information (RDI) information extraction function which extracts a RDI from a stream in a DVD format, and (f2) generates an element in which the RDI is included in the parameter information and add the generated element to the parameter list.

Based on the above aspect, the stream control device according to the third embodiment is described below. Note that the same components are designated by the same reference numerals in the first embodiment, and their structures and functions are the same as described above.

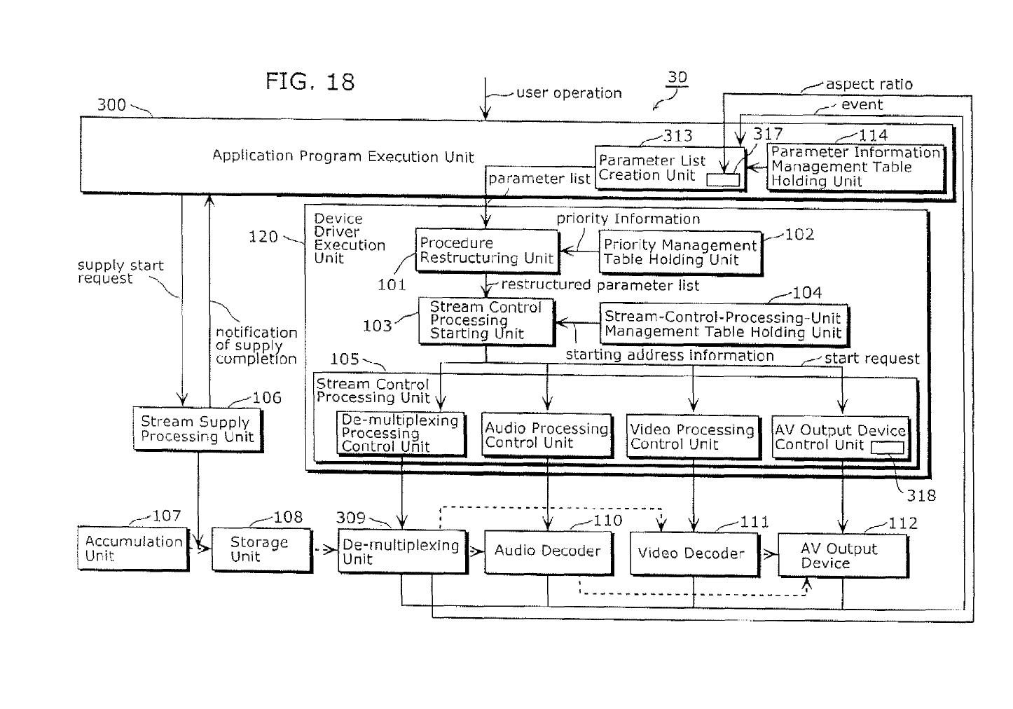

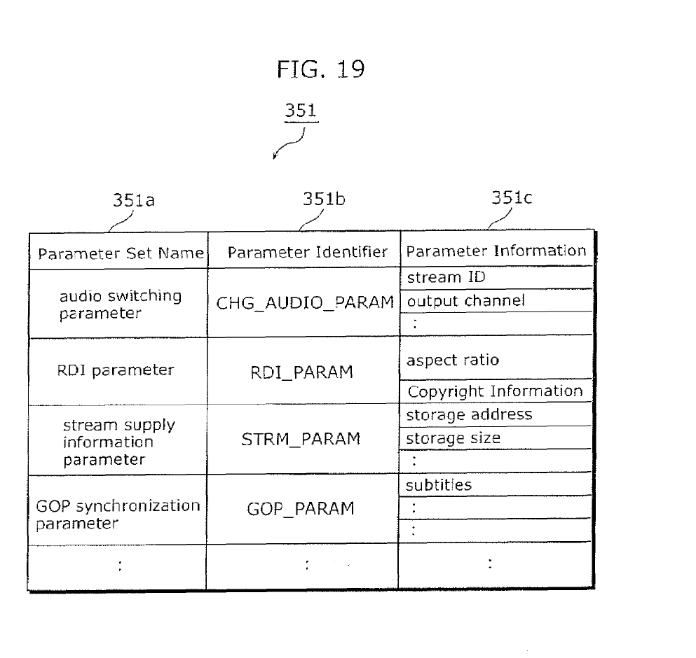

FIG. 18 is a block diagram showing a structure of a stream control device according to the third embodiment. Referring to FIG. 18, the stream control device 30 of the third embodiment differs from the stream control device 10 of the first embodiment in that the application program execution unit 100 is replaced to a application program execution unit 300, and that the de-multiplexing unit 109 is replaced to a de-multiplexing unit 309.

The application program execution unit 300 includes a parameter list creation unit 313 instead of the parameter list creation unit 113.

The parameter list creation unit 313 has a Real-time Data Information (RDI) parameter generation unit 317.

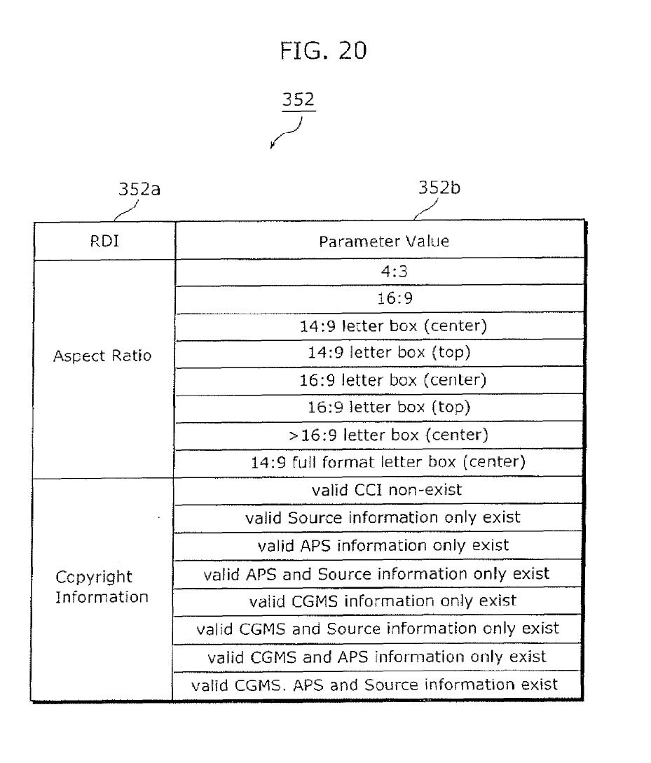

When RDI is received from the de-multiplexing unit 309, the RDI parameter generation unit 317 generates a basic list structure. Here, referring to a “RDI parameter” registered in the parameter information management table (FIG. 19, for example), a parameter identifier of the basic list structure is set to “RDI_PARAM”, and parameter information of the basic list structure is set to “aspect ratio” and “copyright information”. The aspect ratio and the copyright information are selected based on the RDI (FIG. 20, for example) notified from the de-multiplexing unit 309. Further, the RDI parameter generation unit 317 sets a next pointer of the basic list structure to NULL, and adds the resulting basic list structure next to the last basic list structure in the parameter list.

FIG. 19 is a diagram showing one example of the parameter information management table according to the third embodiment. Referring to FIG. 19, the parameter information management table 351 includes a record in which a parameter set name (column 351a), a parameter identifier (column 351b), and parameter information (column 351c) are associated with one another. Here, as an example, the parameter information management table 351 includes a record in which “RDI parameter”, “RDI_PARAM”, and “aspect ratio, copyright information” are associated with one another.

FIG. 20 is a diagram showing a data structure of RDI according to the third embodiment. As shown in FIG. 20, the RDI (column 352a) includes a aspect ratio and copyright information.

Each parameter value (column 352b) is as follows.

As an aspect ratio, “4:3”, “16:9”, “14:9 letter box (center)”, “14:9 letter box (top)”, “16:9 letter box (center)”, “16:9 letter box (top)”, “>16:9 letter box (center)”, or “14:9 full format letter box (center)” is selected.

As copyright information, “valid CCI non-exist”, “valid Source information only exist”, “valid APS information only exist”, “valid APS and Source information only exist”, “valid CGMS information only exist”, “valid CGMS and Source information only exist”, “valid CGMS and APS information only exist”, or “valid CGMS, APS and Source information exist” is selected.

Next, as shown in FIG. 18, the de-multiplexing unit 309 provides RDI regarding a stream to be reproduced, to the RDI parameter generation unit 317 in the parameter list creation unit 313.

Note that the AV output device control unit further includes an additional information control unit 318.

The additional information control unit 318 controls the AV output device to multiplex the aspect ratio and the copyright information into video signals.

Next, processing performed by the stream control device 30 having the above-described structure is described. Note that the same steps are designated by the same reference numerals in the first embodiment, and their operations are the same as described above.

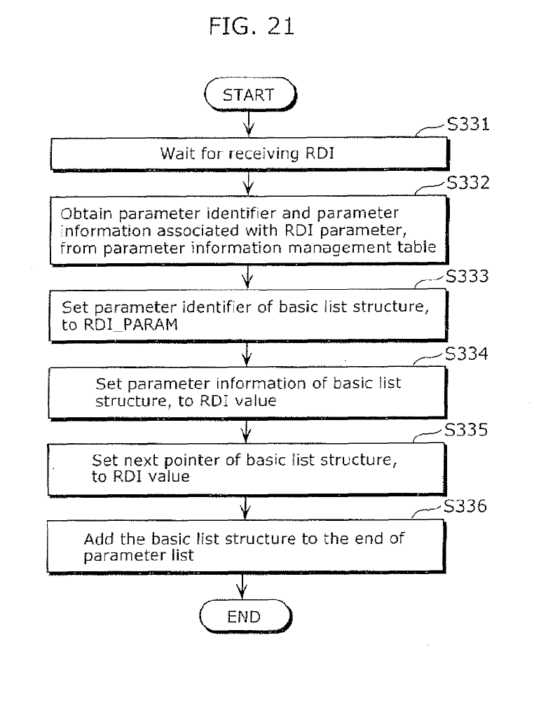

FIG. 21 is a flowchart of processing performed by the application program execution unit according to the third embodiment. Referring to FIG. 21, when RDI is received from the de-multiplexing unit 309 (S331), by referring to a RDI parameter registered in the parameter information management table 351 (FIG. 19, for example) based on the received RDI (S332), the RDI parameter generation unit 317 sets a parameter identifier to “RDI_PARAM” (S333) and parameter information to an aspect ratio and copyright information, thereby generating a basic list structure. The aspect ratio and the copyright information are selected referring to the RDI (FIG, 20, for example) notified from the de-multiplexing unit 309 (S334). A next pointer of the basic list structure is set to NULL (S335), and the resulting basic list structure is added next to the last basic list structure in the parameter list (S336).

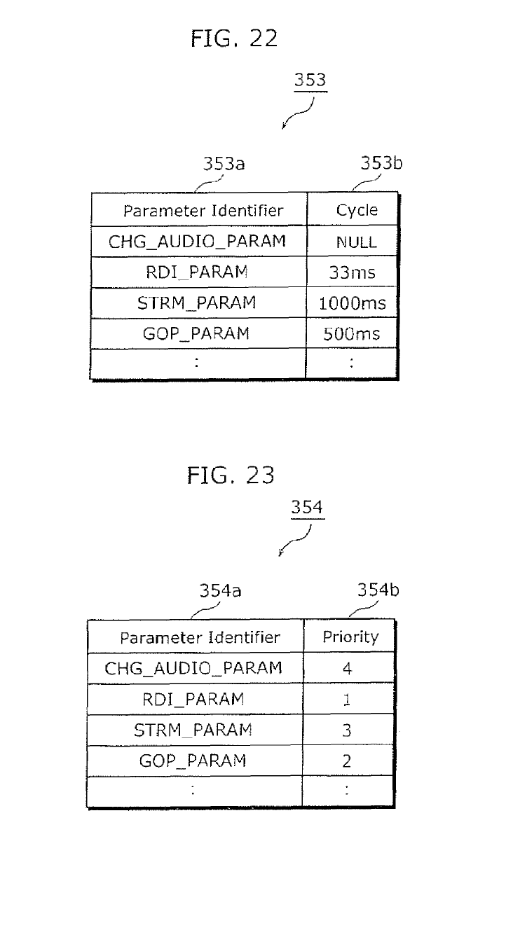

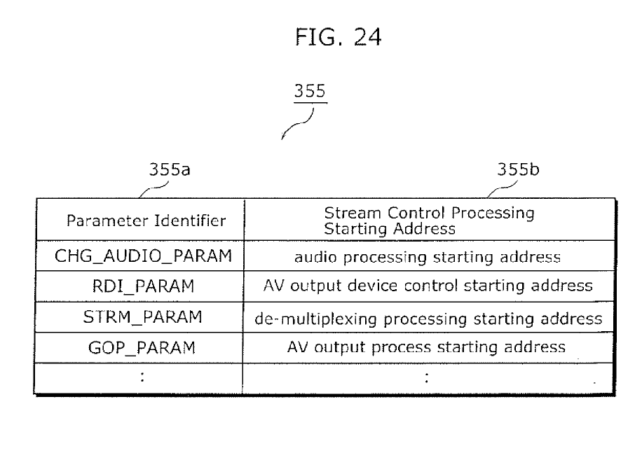

Then, the parameter list created in the application program execution unit 300 is sorted in a priority order of the parameters by the procedure restructuring unit 101. As shown in the cycle management table 353 (FIG. 22, for example), RDI_PARAM has a setting cycle 33 ms and needs to be processed prior to any other parameters, so that a priority of RDI_PARAM is set to “1” as shown in the priority management table 354 (FIG. 23, for example). Therefore, the parameter list is sorted so that RDI_PARAM is positioned as the first structure in the parameter list. Firstly, the stream control processing starting unit 103 obtains “AV-output-device-control-unit starting address” associated with “RDI_PARAM” from the stream-control-processing-unit management table 355 (FIG. 24, for example) to be started. “RDI_PARAM” is processed in the additional information control unit 318 of the AV output device control unit.

FIG. 22 is a diagram showing one example of a cycle management table according to the third embodiment. Referring to FIG. 22, the cycle management table 353 includes: a record in which a parameter identifier (column 353a) is associated with a cycle (column 353b). Here, as an example, the cycle management table 353 includes a record in which “RDI_PARAM” is associated with “33 ms”.

FIG. 23 is a diagram showing one example of a priority management table according to the third embodiment. Referring to FIG. 23, the priority management table 354 includes a record in which a parameter identifier (column 354a) is associated with a priority (column 354b). Here, as an example, the priority management table 354 includes a record in which “PRDI_PARAM” is associated with a priority “1”.

FIG. 24 is a diagram showing one example of a stream-control-processing-unit management table according to the third embodiment. Referring to FIG. 24, the stream-control-processing-unit management table 355 includes a record in which a parameter identifier (column 355a) is associated with a stream control processing starting address (column 355b). Here, as an example, the stream-control-processing-unit management table 355 includes a record in which “RDI_PARAM” is associated with “AV-output-device-control-unit starting address”.

As described above, in the stream control device 30 according to the third embodiment, even if information included in an audio-visual stream is detected by the de-multiplexing unit 309 and then set in the AV output device 112, the information is processed based on the priority information, so that it is possible to ensure real-time processing, which provides a user with desirable visual results.

This means that in the stream control device 10 according to the first embodiment, the application program execution unit 100 cannot detect information received from the de-multiplexing unit 109, so that it is impossible to set the aspect ratio and the copyright information included in the de-multiplexed parameter in the AV output device, like an AV stream in a DVD format, which fails to realize desirable visual perception of a user.

However, the stream control device 30 according to the third embodiment includes the RDT parameter generation unit 317 and an additional information control unit 318, in order to generate a RDI parameter to be set in the AV output device 112, based on an aspect ratio and copyright information received from the de-multiplexing unit 309, so that desirable visual perception of a user can be realized in reproducing data in a DVD format.

### Fourth Embodiment

Next, the fourth embodiment according to the present invention is described with reference to the drawings.

In the stream control device according to the fourth embodiment, (g) the procedure restructuring function: extracts a bit rate and a transfer size of the stream from the parameter list; (g1) calculates a starting cycle of the stream processing function, according to the bit rate and the transfer size; and (g2) decides the priority based on the starting cycle, and update the priority management table using the decided priority.

Based on the above aspect, the stream control device according to the fourth embodiment is described below. Note that the same components are designated by the same reference numerals in the first embodiment, and their structures and functions are the same as described above.

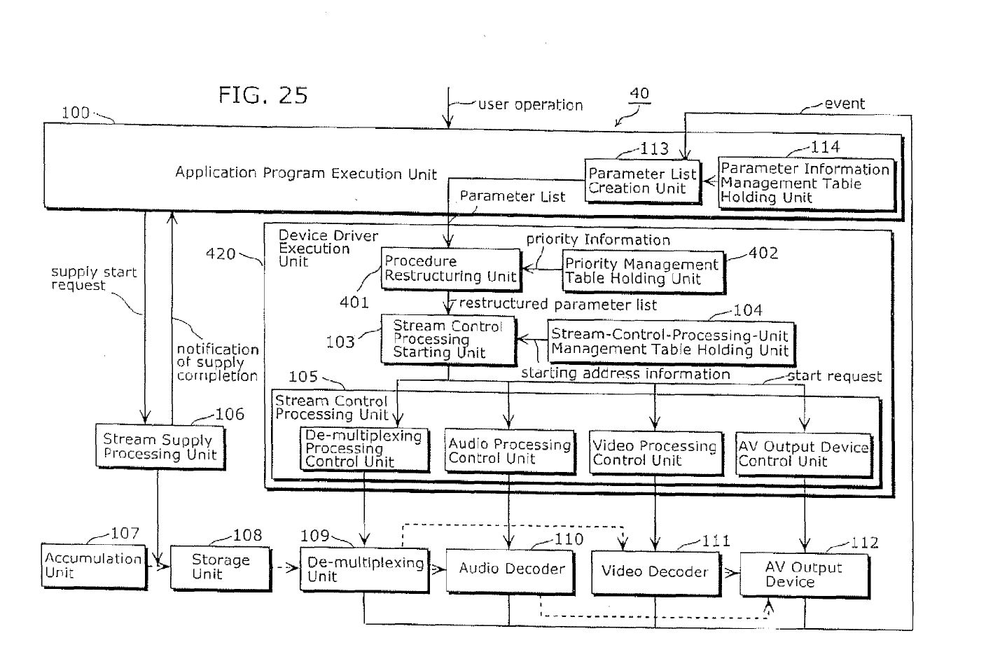

FIG. 25 is a block diagram showing a structure of a stream control device according to the fourth embodiment. Referring to FIG. 25, the stream control device 40 of the fourth embodiment differs from the stream control device 10 of the first embodiment in that the device driver execution unit 120 is replaced to a device driver execution unit 420.

The device driver execution unit 420 includes a procedure restructuring unit 401 and a priority management table holding unit 402, instead of the procedure restructuring unit 101 and the priority management table holding unit 102.

When a parameter list is received from the parameter list creation unit 113, the procedure restructuring unit 401 scans the received parameter list and retrieves basic list structures from the parameter list sequentially from the first basic list structure. The retrieved basic list structure is examined, and if a parameter identifier of the examined basic list structure is “STRM_INFO_PARAM”, then “bit rate” and “transfer size of one transfer” are obtained from parameter information of the basic list structure. Using the obtained “bit rate” and “transfer size of one transfer”, a stream transmission cycle is calculated based on the following equation 1.

stream transfer cycle=transfer size of one transfer/bit rate [equation 1]

Then, the procedure restructuring unit 401 registers the calculated result into the cycle management table. Moreover, the basic list structure identified as “SITR_INFO_PARAM” is deleted from the parameter list. The above-described processing is repeated up to the last basic list structure in the parameter list.

Furthermore, the procedure restructuring unit 401 sorts the cycle management table in a order of shorter cycles, and assigns a higher priority to a shorter cycle, thereby updating the priority management table. Note that cycles of the same time period are assigned with the same priority.

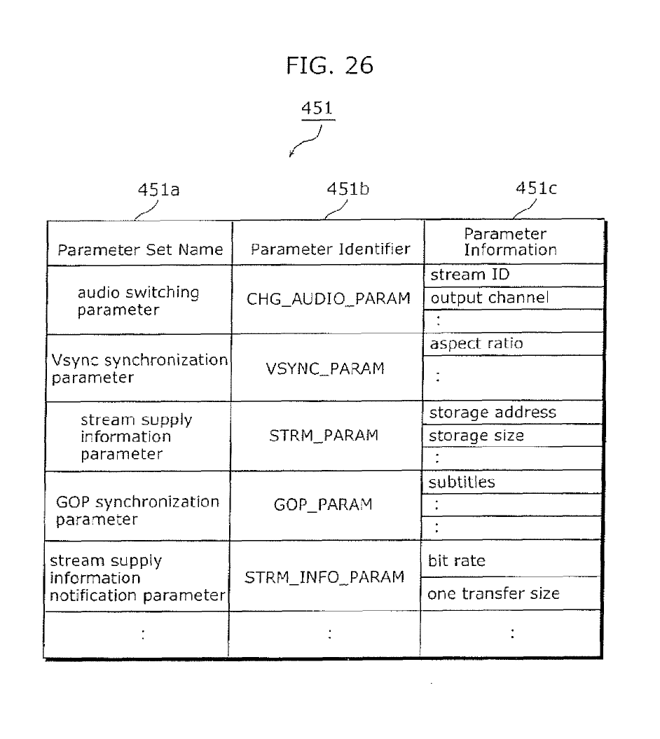

FIG. 26 is a diagram showing one example of a parameter information management table according to the fourth embodiment. Referring to FIG. 26, the parameter information management table 451 includes a record in which a parameter set name (column 451a), a parameter identifier (column 451b), and parameter information (column 451c) are associated with one another. Here, as an example, the parameter information management table 451 includes a record in which “stream supply information notification parameter”, “STRM_INFO_PARAM”, and “bit rate, transfer size of one transfer” are associated with one another.

Next, as shown in FIG. 25, the priority management table holding unit 402 holds the priority management table 154 (FIG. 5, for example) which is updated by the procedure restructuring unit 401.

Next, processing performed by the stream control device 40 having the above-described structure is described. Note that the same steps are designated by the same reference numerals in the first embodiment, and their operations are the same as described above.

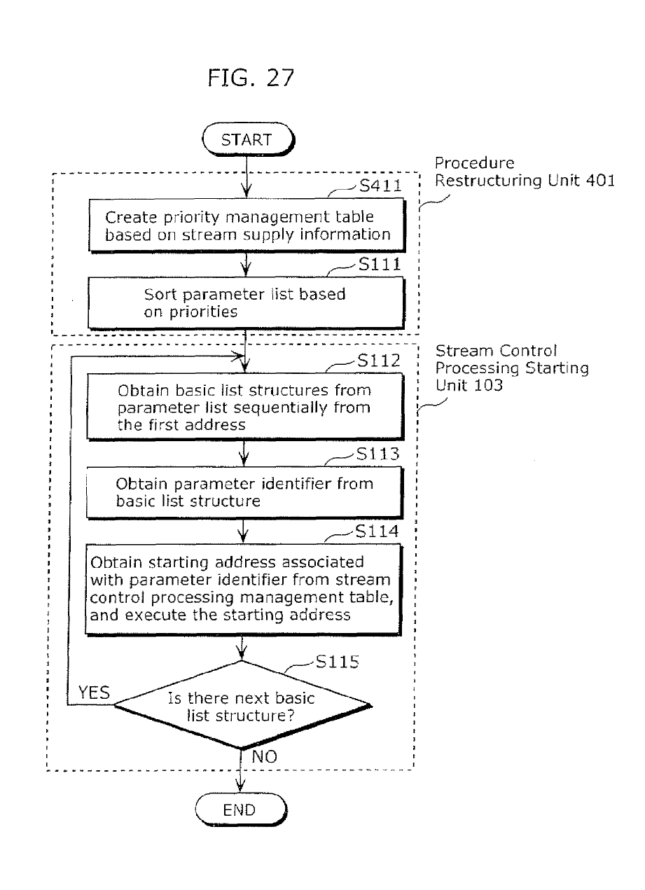

FIG. 27 is a flowchart of processing performed by the device driver execution unit 420 according to the fourth embodiment. Referring to FIG. 27, the procedure restructuring unit 401 updates the priority management table based on the stream supply information (S411).

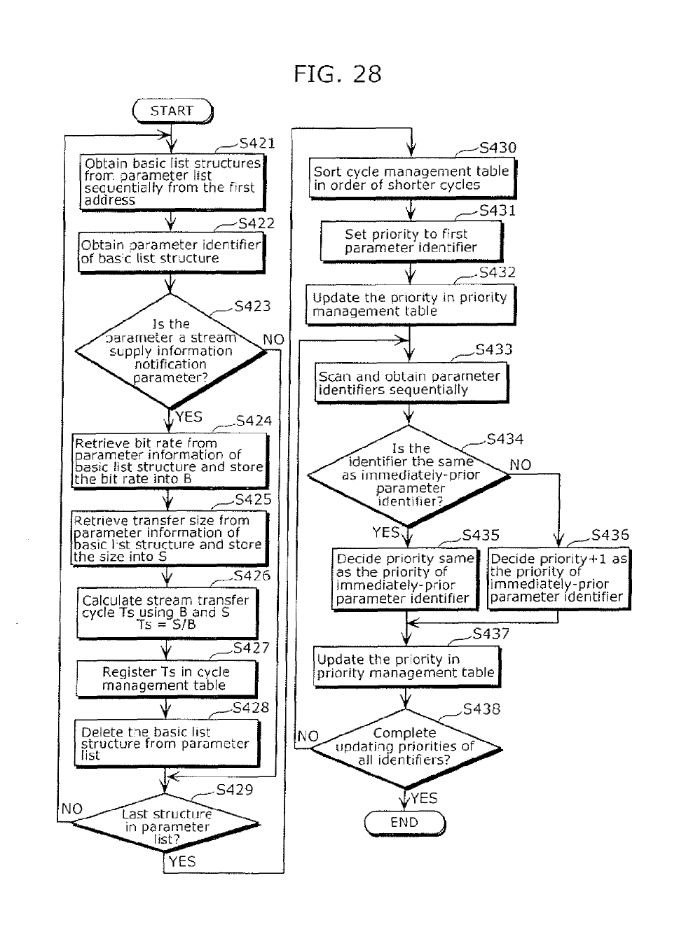

Here, as shown in FIG. 28, the procedure restructuring unit 401 sequentially scans the parameter list received from the application program execution unit 100 and sequentially retrieves basic list structures from the parameter list (S421). By referring to a parameter identifier of the retrieved basic list structure (S422), if the parameter identifier is “STRM_INFO_PARAM” (YES at S423), then a bit rate (B) and a transfer size of one transfer (S) are retrieved from the parameter information (S424 and S425). Then, a stream transfer cycle (Ts) is calculated (S426), and a result of the calculation is registered in the cycle management table (S427). A basic list structure whose parameter identifier is registered as “STRM_INFO_PARAM” is deleted from the parameter list (S428). The above-described steps are repeated up to the last basic list structure in the parameter list (S429).

Next, the procedure restructuring unit 401 sorts the cycle management table in a order of shorter cycles (S430), then assigns a priority “1” to a parameter identifier of the first basic list structure (S431), and updates the priority in the priority management table 154 (S432). Then, a parameter identifier of a next basic list structure is obtained (S433), and a judgment is made as to whether or not a cycle, which is associated with a parameter identifier of a basic list structure immediately prior to the next basic list structure (hereinafter, referred to as a prior basic list structure), is the same as a cycle, which is associated with a parameter identifier of the next basic list structure (S434).

As a result of the judgment, if the cycles are the same, then the procedure restructuring unit 401 sets a priority associated with the parameter identifier of the next basic list structure, to be the same as a priority associated with the parameter identifier of the prior basic list structure (S435). On the other hand, if the cycles are different, then the procedure restructuring unit 401 sets a priority associated with the parameter identifier of the next basic list structure, to be a priority obtained by adding “1” to a priority associated with the parameter identifier of the prior basic list structure priority (S436). The set priority is associated with the parameter identifier of the next basic list structure, in order to update the priority in the priority management table (S437).

Then, the procedure restructuring unit 401 repeats the above-described steps until the priority updating is performed for parameter identifiers of all basic list structures in the parameter list (S438).

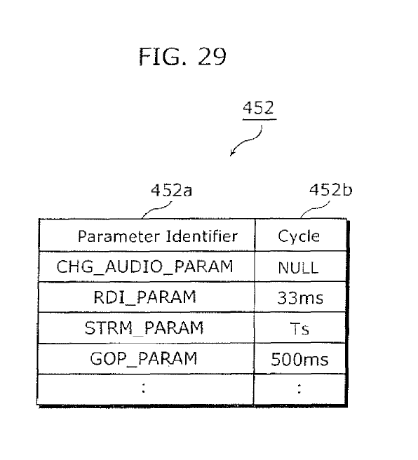

FIG. 29 is a diagram showing one example of a cycle management table according to the fourth embodiment. Referring to FIG. 29, the cycle management table 452 includes: a record in which a parameter identifier (column 452a) is associated with a cycle (column 452b). Here, as an example, the cycle management table 452 includes a record in which “STRM_PARAM” is associated with “Ts”.

Here, a cycle “Ts” of “STRM_PARAM” is uncertain until the cycle is calculated using “bit rate, transfer size of one transfer” associated with “STRM_INFO_PARAM” in the parameter information management table 451 (FIG. 26, for example).

As described above, the stream control device 40 according to the fourth embodiment can dynamically change a priority of STRM_PARAM, according to a bit rate or a transfer size of one transfer, so that it becomes possible to reproduce streams of various bit rates.

This means that, since a cycle of STRM_PARAM varies depending on a bit rate and a transfer size of a stream, a priority of STRM_PARAM needs to be changed according to the cycle. In the stream control device 10 according to the first embodiment, the cycles are fixed, so that it is impossible to change the priorities dynamically.

However, the stream control device 40 according to the fourth embodiment can change processing performed by the procedure restructuring unit 122, for example by updating the priority management table using as a trigger the stream supply information notification parameter registered in the parameter information management table, so that it is possible to dynamically change the priority of STRM_PARAM in the priority management table.

### Fifth Embodiment

Next, the fifth embodiment according to the present invention is described with reference to the drawings.

In the stream control device according to the fifth embodiment, (h) the device driver execution function includes (h1) a bit rate management function: extracts a bit rate of the stream and a stream identifier allocated to the stream from the parameter list; and creates and holds a bit rate management table in which the bit rate is associated with the stream identifier, and (h2) the procedure restructuring function restructures the parameter list by sorting the elements in the liest based on the priority management table and the bit rate management table.

Based on the above aspect, the stream control device according to the fifth embodiment is described below. Note that the same components are designated by the same reference numerals in the first embodiment, and their structures and functions are the same as described above.

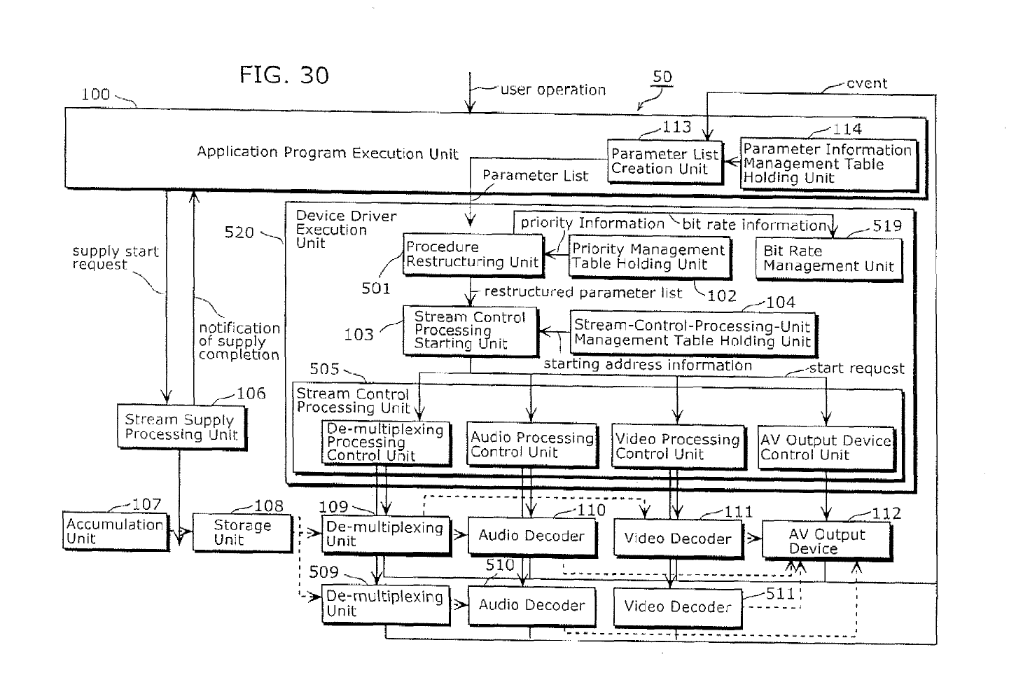

FIG. 30 is a block diagram showing a structure of a stream control device according to the fifth embodiment. Referring to FIG. 30, the stream control device 50 of the fifth embodiment differs from the stream control device 10 of the first embodiment in that the application program execution unit 100 and the device driver execution unit 120 are replaced to an application program execution unit 500 and a device driver execution unit 520, respectively.

The application program execution unit 500 includes a parameter list creation unit 513 instead of the parameter list creation unit 113.

The parameter list creation unit 513 creates a parameter list including basic list structures. Each of the basic list structures has a stream identifier as a member.

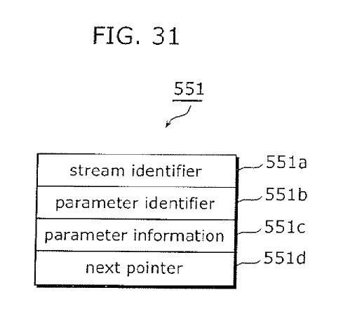

FIG. 31 is a diagram showing a data structure of the basic list structure according to the fifth embodiment. Referring to FIG. 31, the basic list structure 551 included in the parameter list has, as members, a stream identifier (member 551a), a parameter identifier (member 551b), parameter information (member 551c), a next pointer (member 551d), and the like. In other words, the basic list structure 551 differs from the basic list structure 151 (FIG. 2, for example) of the first embodiment in that the stream identifier (member 551a) is newly added. Here, the stream identifier is an identifier unique to each stream.

Next, as shown in FIG. 30, the device driver execution unit 520 includes a procedure restructuring unit 501 instead of the procedure restructuring unit 101. The device driver execution unit 520 further includes a bit rate management unit 519.

When a parameter list is received from the parameter list creation unit 113, the procedure restructuring unit 501 provides the received parameter list to the bit rate management unit 519.

When the parameter list is received from the procedure restructuring unit 501, the bit rate management unit 519 analyzes the received parameter list. Here, the received parameter list is scanned to retrieve basic list structures from the parameter list. The retrieved basic list structure is examined to judge whether or not a parameter identifier of the basic list structure is “STRM_BTRATE_INFO”. If the parameter identifier of the examined basic list structure is “STRM_BITRATE_INFO”, then bit rate information is obtained from parameter information of the basic list structure. The obtained bit rate information is registered in the to bit rate management table in association with the stream identifier. Then, the basic list structure is deleted from the parameter list. Note that the hit rate management unit 519 holds a bit rate management table.

Next, processing performed by the stream control device 50 having the above-described structure is described. Note that the same steps are designated by the same reference numerals in the first embodiment, and their operations are the same as described above.

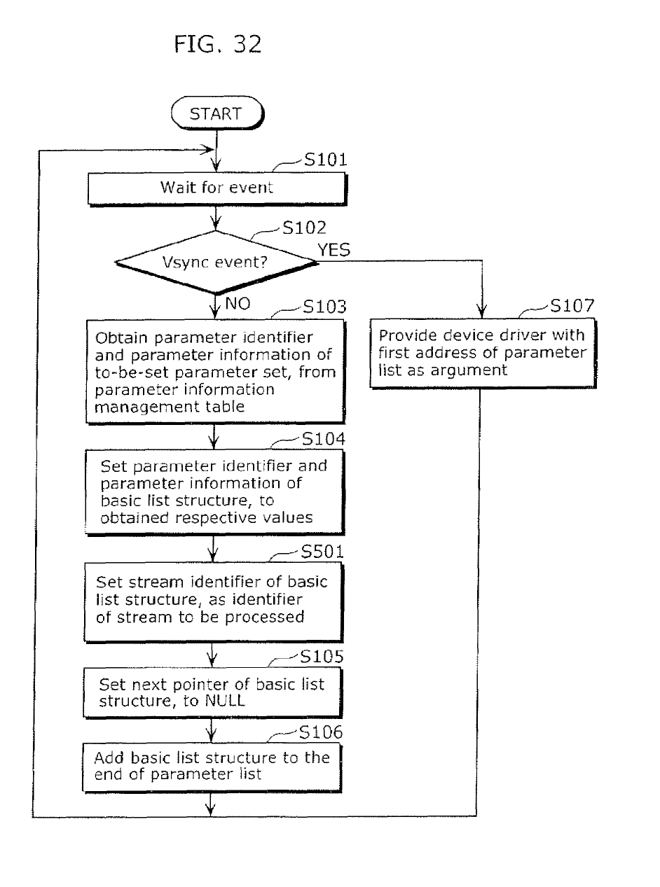

FIG. 32 is a flowchart of processing performed by the application program execution unit according to the fifth embodiment. Referring to FIG. 32, in order to designate a stream to be processed, the application program execution unit 500 sets, regarding each stream, respective stream identifiers assigned to de-multiplexing units 109 and 509, audio decoders 110 and 510, and video decoders 111 and 511, to a stream identifier of the basic list structure (S501).

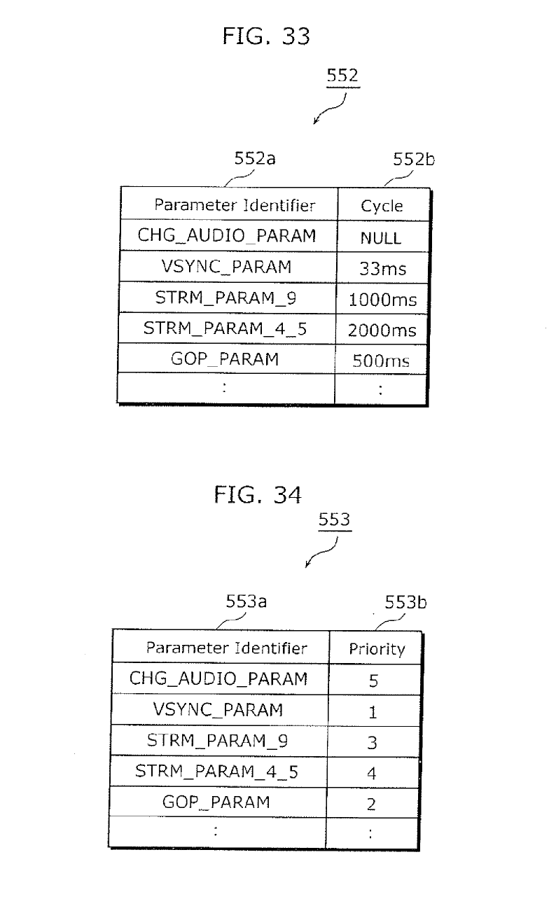

Here, as one example, bit rates of streams processed by the stream control device 50 are multiple bit rates, assuming that the bit rates are 9 Mbps and 4.5 Mbps, respectively. Furthermore, a parameter identifier is set for each of the bit rates. For example, when a bit rate is 9 Mbps, a parameter identifier of the bit rate is “STRM_PARAM_{—}9”, and when a bit rate is 4.5 Mbps, a parameter identifier of the bit rate is “STRM_PARAM_{—}4_{—}5”. Then, a cycle is registered in the cycle management table (FIG. 33, for example), and a priority is registered in the priority management table (FIG. 34, for example), in association with the parameter identifier set for each of the bit rates.

FIG. 33 is a diagram showing one example of the cycle management table according to the fifth embodiment. Referring to FIG. 33, the cycle management table 552 includes: a record in which a parameter identifier (column 552a) is associated with a cycle (column 552b). Here, as an example, the cycle management table 552 includes: a record in which “STRM_PARAM_{—}9” is associated with “100 ms”; and a record in which “STRM_PARAM_{—}4_{—}5” is associated with “2000 ms”.

FIG. 34 is a diagram showing one example of a priority management table according to the fifth embodiment. Referring to FIG. 34, the priority management table 553 includes a record in which a parameter identifier (column 553a) is associated with a priority (column 553b). Here, as an example, the priority management table 553 includes: a record in which “STRM_PARAM_{—}9” is associated with “3”; and a record in which “STRM_PARAM_{—}4_{—}5” is associated with “4”.

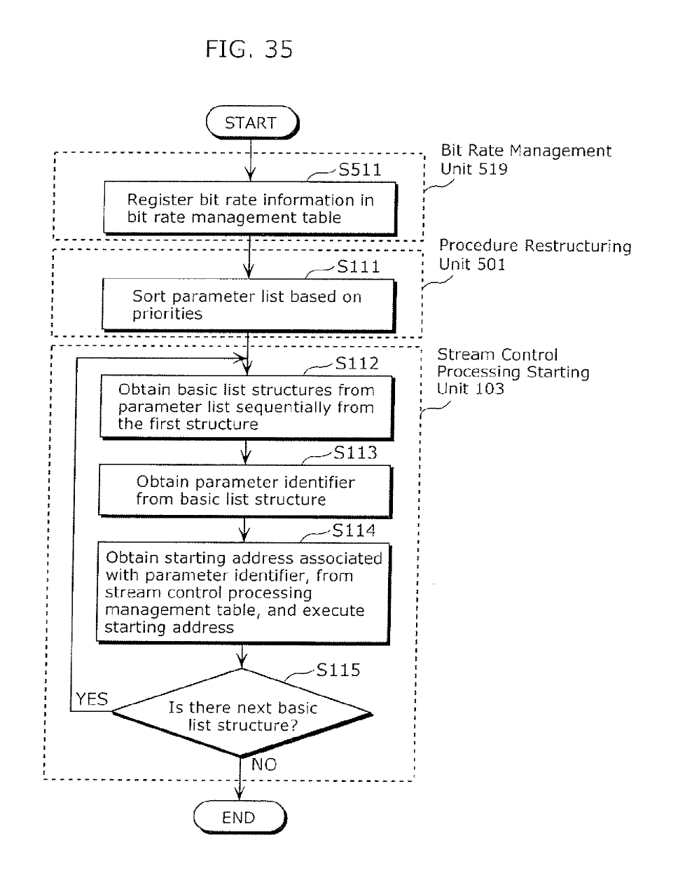

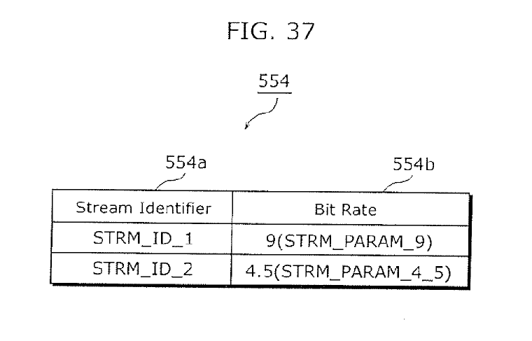

FIG. 35 is a flowchart of processing performed by the device driver execution unit according to the fifth embodiment. Referring to FIG. 35, the bit rate management unit 519 receives a parameter list from the procedure restructuring unit 501, analyzes the received parameter list, and registers bit rate information registered in the parameter list to the bit rate management table (FIG. 37, for example) (S511).

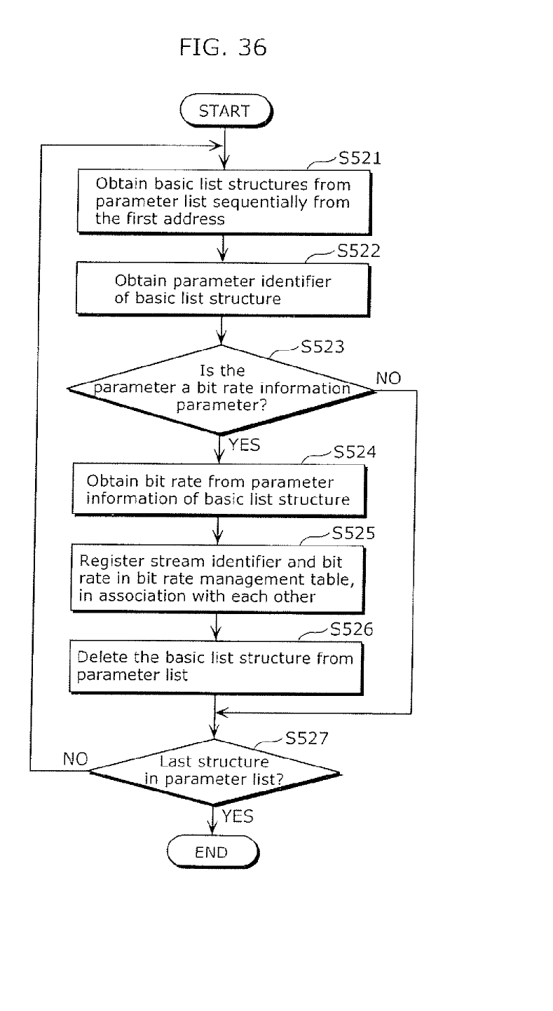

Here, as shown in FIG. 36, the bit rate management unit 519 scans the parameter list received from the procedure restructuring unit 501, and retrieves basic list structures sequentially from the parameter list (S521). By referring to a parameter identifier of the retrieved basic list structure (S522), a judgment is made as to whether or not the parameter identifier of the retrieved basic list structure is “STRM_BITRATE_INFO” (S523).

As a result of the judgment, if the parameter identifier is “STRM_BITRATE_INFO” (YES at S523), then bit rate information is obtained from parameter information of the retrieved basic list structure (S524). Then, the obtained bit rate information is registered in the bit rate management table (FIG. 37, for example), in association with a stream identifier of the retrieved basic list structure (SS25). Further, a basic list structure whose parameter identifier is registered as “STRM_BITRATE_INFO” is deleted from the parameter list (S526). Subsequently, the above-described steps are repeated up to the last basic list structure in the parameter list (S527).

FIG. 37 is a diagram showing one example of the bit rate management table according to the fifth embodiment. Referring to FIG. 37, the bit rate management table 554 includes a record in which a stream identifier is associated with a bit rate. Here, as an example, the bit rate management table 554 includes: a record in which “STRM_ID_{—}1” is associated with “9 (STRM_PARAM_{—}9)”; and a record in which “STRM_ID_{—}2” is associated with “4.5 (STRM_PARAM_{—}4_{—}5)”.

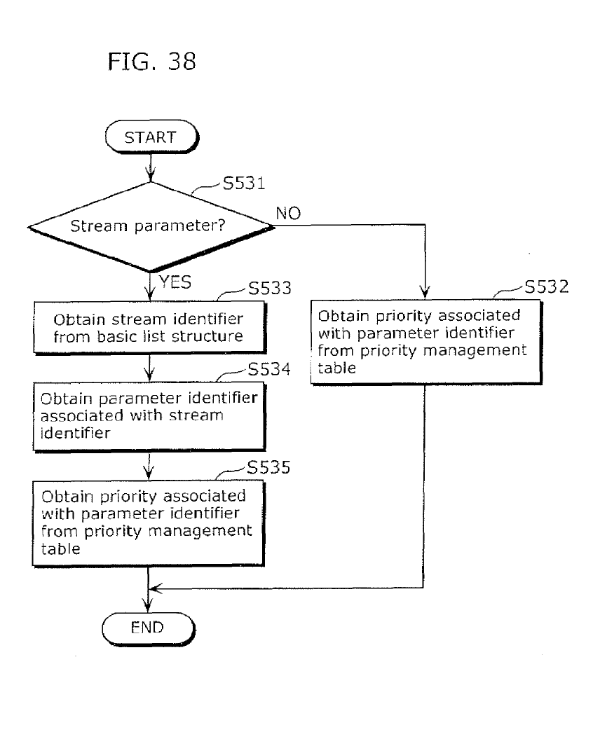

Note that, referring to FIG. 38, in order to obtain a priority from the priority management table 5S3 (FIG. 34, for example), the procedure restructuring unit 501 firstly judges whether or not a parameter identifier of the basic list structure is “STRM_PARAM” (S531).

As a result of the judgment, if the parameter identifier is not “STRM_PARAM” (NO at S531), then the procedure restructuring unit 501 obtains a priority from the priority management table 553 (FIG. 34, for example) (S532). On the other hand, if the parameter identifier is “STRM_PARAM” (YES at S531), then a stream identifier of the basic list structure is obtained (S533). Then, a bit rate associated with the obtained stream identifier is obtained from the bit rate management table 554 (FIG. 37, for example). Based on the obtained bit rate, a parameter identifier is specified (S534). Using the specified parameter identifier, a priority is obtained from the priority management table 553 (FIG. 34, for example) (S535).

As described above, the stream control device 50 according to the fifth embodiment can process multiple streams. Further, it is possible to define and use a priority of STRM_PARAM for each stream, so that, even if streams of various bit rates are processed, the application program execution unit 500 does not need to consider a order of processing the streams.

Furthermore, the defining of the priority management table for each stream identifier eliminates judgment of STRM_PARAM, so that it is possible to process various parameters having different cycles which are set depending on respective bit rates.

This means that, when it is necessary to realize multi-stream processing for processing multiple streams using respective stream identifiers, for example in double-screen real-time reproduction apparatuses and the like, it is required to process streams of different bit rates at the same time.

In order to achieve the above, the stream control device 50 according to the fifth embodiment has the bit rate management unit 519 to process multiple streams and multiple bit rates.

### Others

Note that the stream control device according to the present invention may include a Central Processing Unit (CPU), a Large Scale Integration (LSI), a Random Access Memory (RAM), a Read Only Memory (ROM), a Hard Disk Drive (HDD), a network interface, and the like. The stream control device according to the present invention may further include a drive device, which is readable/writable to a portable recording medium, such as a DVD-RAM, a Blu-ray disk, or a Secure Digital (SD) memory card.

Note also that each of the functions in the stream control device may be realized by executing a stream control program which is installed in a HDD, a ROM, or the like to control the stream control device.

Here, the stream control program may be recorded in a recording medium readable in a hardware system, such as a computer system or an embedded system. Further, the stream control program may be read out by other hardware systems via the recording medium, to be executed. Thereby, each of the functions in the stream control device can be realized in other hardware systems. Examples of the computer-readable recording medium are an optical recording medium (for example, CD-ROM), a magnetic recording media (for example, hard disk), a magneto-optic recording medium (for example, MO), a semiconductor memory (for example, memory card), and the like.

Furthermore, the stream control program may be held in a hardware system connected to a network. Further, the stream control program may be downloaded via the network to other hardware to be executed. Thereby, each of the functions in the stream control device can be realized in other hardware systems. Examples of the network are the Internet, a local area network, a ground broadcast network, a satellite broadcast network, a Power Line Communication (PLC), a mobile telephone network, a cable communication network (for example, IEEE802.3), a radio communication network (for example, IEEE802.11), and the like.

Note also that the stream control device may be an embedded system, such as a digital television, a digital recorder, a digital camcorder, a game machine, an IP telephone, or a portable telephone.

Although only some exemplary embodiments of the present invention have been described in detail above, those skilled in the art will be readily appreciate that many modifications are possible in the exemplary embodiments without materially departing from the novel teachings and advantages of the present invention, Accordingly, all such modifications are intended to be included within the scope of the present invention.

### INDUSTRIAL APPLICABILITY

The present invention is provided as a stream control device and the like to enhance software standardization especially for various commercial audio-visual apparatuses. The present invention can be used as a stream control device or the like which executes software, such as SD-Movie and DVD-Movie.

What is claimed is:

1. A stream control device comprising:
a stream processing unit operable to decode a stream and outputs the decoded data;
a parameter list storage unit in which a parameter list is stored, the parameter list including, as elements, list structures connected in series, each of which has parameter information characterizing the processing of said stream processing unit;
a device driver execution unit operable to execute, based on the parameter list, a device driver which controls the processing of said stream processing unit; and
an application program execution unit operable to execute an application program which provides said device driver execution unit with a first address of the parameter list as an argument.

2. The stream control device according to claim 1,
wherein said device driver execution unit includes:
a priority management table holding unit operable to hold a priority management table in which a priority is registered, the priority being assigned to each element indicated by the parameter information; and
a procedure restructuring unit operable to restructure the parameter list by sorting the elements included in the parameter list, based on the priority management table.

3. The stream control device according to claim 2,
wherein said device driver execution unit includes
a parameter-processing-type-management-table holding unit operable to hold a parameter processing type management table in which a processing type is registered, the processing type indicating whether or not synchronization with the processing of said stream processing unit is required, and
said procedure restructuring unit is operable to:
classify each of the elements into an element indicating the synchronization with the processing of said stream processing unit or an element not indicating the synchronization with the processing;
create a synchronization parameter list including the element indicating the synchronization, and a non-synchronization parameter list including the element not indicating the synchronization; and
restructure the non-synchronization parameter list, by sorting the elements included in the list based on the priority management table.

4. The stream control device according to claim 2,
wherein said procedure restructuring unit is operable to:
extract a bit rate and a transfer size of the stream from the parameter list;
calculate a starting cycle of said stream processing unit, according to the bit rate and the transfer size; and
decide the priority based on the starting cycle, and update the priority management table using the decided priority.

5. The stream control device according to claim 2,
wherein said device driver execution unit includes
a bit rate management unit operable to: extract a bit rate of the stream and a stream identifier allocated to the stream from the parameter list; and creates and holds a bit rate management table in which the bit rate is associated with the stream identifier, and
said procedure restructuring unit is operable to
restructure the parameter list by sorting the elements in the liest based on the priority management table and the bit rate management table.

6. The stream control device according to claim 1,
wherein said application program execution unit includes:
a parameter information management table holding unit operable to hold a parameter information management table in which the parameter information is registered; and
a parameter list creation unit operable to create the parameter list based on the parameter information management table.

7. The stream control device according to claim 6,
wherein said parameter list creation unit
includes a Real-time Data Information (RDI) information extraction unit operable to extract a RDI from a stream in a DVD format, and
is operable to generate an element in which the RDI is included in the parameter information and add the generated element to the parameter list.

8. The stream control device according to claim 1,
wherein said stream processing unit includes
a plurality of functions, each of which is operable to perform individual processing for the stream, and
said device driver execution unit includes:
a stream control processing unit having a plurality of control functions which controls said functions, respectively;
a stream control processing management table holding unit operable to hold a stream control processing management table in which respective starting addresses for starting said control functions are registered; and
a stream control processing starting unit operable to start said control functions, respectively, according to the respective elements in the parameter list, based on the stream control processing management table.

9. A stream control method comprising:
decoding a stream and outputting the decoded data;
executing a device driver which controls said outputting, based on a parameter list including, as elements, list structures connected in series, each of which has parameter information characterizing said outputting; and
executing an application program which provides a first address of the parameter list as an argument, for said executing of the device driver.

10. A stream control program causing a computer system to execute:
decoding a stream and outputting the decoded data;
executing a device driver which controls said outputting, based on a parameter list including, as elements, list structures connected in series, each of which has parameter information characterizing said outputting; and
executing an application program which provides a first address of the parameter list as an argument, for said executing of the device driver.
